(19) United States
(12) Patent Application Publication
(10) Pub. No.: US 2008/0312395 A1
(43) Pub. Date: Dec. 18, 2008

(54) Acrylate Polymers Based on Tert.- Butyl Acrylate Which are to be Used in Spray Formulations

(75) Inventors: Gabi Muller, Mannheim (DE); Son Nguyen Kim, Hemsbach (DE); Claudia Wood, Weinheim (DE); Vittoria Signori, L. Hiawatha, NJ (US); Gerd Schuh, Schwegenheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF AKTIENGESELLSCHAFT, LUDWIGSHAFEN (DE)

(21) Appl. No.: 10/585,889

(22) PCT Filed: Jan. 13, 2005
(86) PCT No.: PCT/EP2005/000258

§ 371 Date: Aug. 11, 2008

(30) Foreign Application Priority Data
Jan. 16, 2004 (DE) 10 2004 002 650.5

(51) Int. Cl. C08F 20/06

(52) U.S. Cl. 526/317.1

(57) ABSTRACT

The present invention relates to polymers obtainable by free-radical polymerization of
a) 30 to 99% by weight of tert-butyl acrylate and/or tert-butyl methacrylate as monomer A,
b) 1 to 70% by weight of acrylic acid and/or methacrylic acid as monomer B and
c) 0 to 12% by weight of a free-radically copolymerizable monomer or a free-radically copolymerizable monomer mixture as monomer C, where at least one of the monomers C produces a homopolymer with a glass transition temperature of less than 30° C.,
   with the proviso that the % by weight add up to 100, where the K value of the polymers is between 27 and 38 and where the polymerization is carried out in the presence of a regulator if the K value of the polymers is less than or equal to 35,
      and to the use of these polymers in preparations for, in particular, cosmetics and oral care and dental care.

The present invention relates to polymers obtainable by free-radical polymerization of
a) 30 to 99% by weight of tert-butyl acrylate and/or tert-butyl methacrylate as monomer,
b) 1 to 70% by weight of acrylic acid and/or methacrylic acid as monomer B and
c) 0 to 12% by weight of a free-radically copolymerizable monomer or a free-radically copolymerizable monomer mixture as monomer C, where at least one of the monomers C produces a homopolymer with a glass transition temperature of less than 30° C.,
   with the proviso that the % by weight add up to 100, where the K value of the polymers is between 27 and 38, and where the polymerization is carried out in the presence of a regulator if the K value of the polymers is less than or equal to 35,
      and to the use of these polymers in preparations for, in particular, cosmetics and oral care and dental care.

Polymers with film forming properties are used in cosmetics for cosmetic, dermatological, hygiene and/or pharmaceutical formulations and are suitable in particular as adjuvants for hair and skin cosmetics.

EP-A 379 082 describes hair-setting compositions comprising, as film former, copolymers based on tert-butyl acrylate and/or tert-butyl methacrylate with a K value of from 10 to 50, which are obtainable by free-radical polymerization of
A) 75 to 99% by weight of tert-butyl acrylate and/or tert-butyl methacrylate
B) 1 to 25% by weight of acrylic acid and/or methacrylic acid and
C) 0 to 10% by weight of a further free-radically copolymerizable monomer C, and where the carboxyl groups of the copolymers are partially or completely neutralized by amines.

Preferably, the polymers are obtained by solution polymerization.

EP-A 696916 describes hair-setting compositions comprising, as film former, copolymers based on tert-butyl acrylate or tert-butyl methacrylate with a K value of from 10 to 50, obtainable by free-radical polymerization of
A) 30 to 72% by weight of tert-butyl acrylate or tert-butyl methacrylate or a mixture thereof as monomer A,
B) 10 to 28% by weight of acrylic acid or methacrylic acid or a mixture thereof as monomer B and
C) 0 to 60% by weight of a free-radically copolymerizable monomer or a free-radically copolymerizable monomer mixture as monomer C, where at least one of the monomers C produces a homopolymer with a glass transition temperature of less than 30° C.,
   where the carboxyl groups of the copolymers are partially or completely neutralized.

WO 02/38638 describes polymers which are obtainable by free-radical polymerization of
30 to 99% by weight of tert-butyl acrylate and/or tert-butyl methacrylate as monomer A,
1 to 28% by weight of acrylic acid and/or methacrylic acid as monomer B and
0 to 60% by of a free-radically copolymerizable monomer or a free-radically copolymerizable monomer mixture as monomer C, where at least one of the monomers C produces a homopolymer with a glass transition temperature of less than 30° C.,
   where the regulators used are optionally alkanethiols with a C₁₄-C₂₂-carbon chain or alkanethiols with a C₁₀-C₂₂-carbon chain with subsequent hydrogen peroxide treatment.

Stricter environmental regulations and increasing ecological awareness are increasingly demanding ever smaller contents of volatile organic components (VOC) in, for example, hairsprays.

The VOC content in hairsprays is essentially given by the nonaqueous solvents and the propellants. For this reason, water is increasingly being fallen back on as solvent instead of nonaqueous solvents. However, in the field of hairspray formulations in particular, this use of organic solvents has some problems.

For example, formulations of the abovementioned film-forming polymers from the prior art which satisfy the corresponding VOC regulations are, for example, not sprayable or are sprayable only after further dilution and thus are only of limited suitability for use in hairsprays. This in turn leads to films which from time to time do not have the necessary mechanical quality and thus inadequate setting action and poor hold for the hair.

The object of the present invention was to provide polymers for, in particular, cosmetic preparations and preparations for oral care and dental care which can be formulated in solvents or solvent mixtures with an increased water fraction and whose formulations have better sprayability coupled with good mechanical properties of the films formed. Besides the good compatibility with the customary cosmetic ingredients the polymers should provide the hair with good setting and prolonged hold, have good wash-out properties and permit formulation as optically clear VOC-55 aerosols (i.e. with a VOC content of at most 55% by weight).

The object is achieved by the polymers described in the introduction. The object is also achieved, in particular, by polymers obtainable by free-radical polymerization of
a) 60 to 80% by weight of tert-butyl acrylate and/or tert-butyl methacrylate as monomer A,
b) 20 to 40% by weight of acrylic acid and/or methacrylic acid as monomer B and
c) 0 to 12% by weight of a free-radically copolymerizable monomer or a free-radically copolymerizable monomer mixture as monomer C, where at least one of the monomers C produces a homopolymer with a glass transition temperature of less than 30° C.,
   with the proviso that the % by weight add up to 100, where the K value of the polymers is between 27 and 38.

If the K value of the polymers according to the invention is less than or equal to 35, the polymerization is carried out in the presence of regulators. If the K value of the polymers according to the invention is in the range between 35 and 38, then the procedure can optionally be carried out in the presence of regulators.

### Monomers C

To modify the properties of the (meth)acrylate polymer at least one further monomer C may, if appropriate, also be copolymerized. This monomer or at least one of these monomers should produce a homopolymer with a glass transition temperature of less than 30° C. These are preferably monomers which are chosen from the group consisting of C₁-C₁₈-alkyl acrylates, C₁-C₁₈-alkyl methacrylates, N—C₁-C₁₈-alkylacrylamides and N—C₁-C₁₈-alkylmethacrylamides. Particular preference is given to N—C₁-C₄-alkylacrylamides or -methacrylamides or mixtures of two or more of these monomers, particular preference being given to unbranched C₂-C₄-alkyl acrylates on their own or in a mixture with branched N—C₃— to —C₄-alkylacrylamides. Suitable C₁-C₄-alkyl radicals in said (meth)acrylates and (meth)acrylamides are methyl, ethyl, n-propyl, isopropyl, n-butyl, isobutyl, sec-butyl or tert-butyl. Particularly preferred monomers C are ethyl acrylate or a mixture of ethyl acrylate and N-tert-butylacrylamide.

Preferred polymers according to the invention are polymers for whose preparation the provided amount of the monomer C is less than 10% by weight, preferably less than 5% by weight, particularly preferably less than 3% by weight, of the total amount of the monomers. The fraction of the component C is particularly preferably in the range from 0.01 to 3% by weight. Particular preference is also given to polymers for whose preparation the components A and B are polymerized, but not C.

In contrast to the polymers from the prior art, in particular to polymers according to WO 02/38638, the polymers according to the invention are characterized by a significantly improved sprayability of the formulations containing up to at most 55% by weight of organic volatile components, coupled with good mechanical properties of the films. At the same time, the polymers according to the invention exhibit good compatibility with customary cosmetic ingredients, good wash-out properties from, for example, hair, and the ability to be formulated in clear VOC-55 aerosols.

In a preferred embodiment, monomer A is tert-butyl acrylate, monomer B is methacrylic acid and monomer C is ethyl acrylate.

Particularly preferred embodiments are polymers obtainable by free-radical polymerization of from 75 to 80% by weight of tert-butyl acrylate, 20 to 25% by weight of methacrylic acid and 0 to 2% by weight of ethyl acrylate, with the proviso that the % by weight add up to 100, where the K value of the polymers is between 30 and 34 and where the polymerization is carried out in the presence of a regulator.

### Preparation of the Polymers

The acrylate polymers are prepared in a known manner by free-radical polymerization of the monomers A, B and, if appropriate, C. The procedure is carried out in accordance with customary polymerization techniques, for example in accordance with the methods of suspension, emulsion or solution polymerization.

The acrylate polymers are preferably prepared by free-radically initiated aqueous emulsion polymerization of the monomers A, B and, if appropriate, C.

### Emulsion Polymerization

The method of free-radically initiated aqueous emulsion polymerization has been described previously on many occasions and is therefore sufficiently known to the person skilled in the art [cf. e.g. Encyclopedia of Polymer Science and Engineering, Vol. 8, pages 659 to 677, John Wiley & Sons, Inc., 1987; D. C. Blackley, Emulsion Polymerization, pages 155 to 465, Applied Science Publishers, Ltd., Essex, 1975; D. C. Blackley, Polymer Latices, 2^{nd} Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit [Chemistry of our Time] 1990, 24, pages 135 to 142, Verlag Chemie, Weinheim; J. Piirma, Emulsion Polymerization, pages 1 to 287, Academic Press, 1982; F. Hölscher, Dispersionen synthetischer Hochpolymerer [Dispersions of Synthetic High Polymers], pages 1 to 160, Springer-Verlag, Berlin, 1969 and DE-A 40 03422]. The free-radically initiated aqueous emulsion polymerization is usually carried out by dispersely distributing the monomers, usually with co-use of dispersants, in the aqueous medium, and polymerizing using at least one free-radical polymerization initiator.

### Initiators

Suitable free-radical polymerization initiators for the free-radical aqueous emulsion polymerization according to the invention are all those which are able to trigger a free-radical aqueous emulsion polymerization. These may in principle be either peroxides or azo compounds. Redox initiator systems are of course also suitable. Peroxides which may be used are, in principle, inorganic peroxides, such as hydrogen peroxide or peroxodisulfates, such as the mono- or di-alkali metal or ammonium salts of peroxide disulfuric acid, such as, for example, its mono- and di-sodium, -potassium or ammonium salts or organic peroxides, such as alkyl hydroperoxides, for example tert-butyl, p-menthyl or cumyl hydroperoxide, tert-butyl perpivalate, and dialkyl or diaryl peroxides, such as di-tert-butyl or di-cumyl peroxide, 2,5-dimethyl-2,5-di(t)butyl-peroxy(hexane) or dibenzoyl peroxide.

The azo compounds used are essentially 2,2′-azobis(isobutyronitrile), 2,2′-azobis(2,4-dimethylvaleronitrile) and 2,2′-azobis(amidinopropyl) dihydrochloride (AIBA, corresponds to V-50™ from Wako Chemicals), 1,1′-azobis(1-cyclohexanecarbonitrile), 2,2′-azobis(2-amidinopropane)salts, 4,4′-azobis(4-cyanovaleric acid) or 2-(carbamoylazo)isobutyronitrile.

Suitable oxidizing agents for redox initiator systems are essentially the abovementioned peroxides. Corresponding reducing agents which may be used are sulfur compounds with a low oxidation state, such as alkali metal sulfites, for example potassium and/or sodium sulfite, alkali metal hydrogensulfites, for example potassium and/or sodium hydrogen sulfite, alkali metal metabisulfites, for example potassium and/or sodium metabisulfite, formaldehyde sulfoxylates, for example potassium and/or sodium formaldehyde sulfoxylate, alkali metal salts, specifically potassium and/or sodium salts, of aliphatic sulfinic acids and alkali metal hydrogen sulfides, such as, for example, potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid, and reducing saccharides, such as sorbose, glucose, fructose and/or dihydroxyacetone.

The initiators are usually used in amounts up to 10% by weight, preferably 0.02 to 5% by weight, based on the monomers to be polymerized.

### Regulators

The regulators used are preferably alkanethiols. Mixtures of two or more regulators may also be used.

The alkanethiols used are linear and branched alkanethiols with a carbon chain length of C₁₀ to C₂₂. Particular preference is given to linear alkanethiols, and further preference to alkanethiols with a chain length of from C₁₂ to C₂₂, in particular from C₁₂ to C₁₈. Preferred alkanethiols are n-decanethiol, n-dodecanethiol, tert-dodecanethiol, n-tetradecanethiol, n-pentadecanethiol, n-hexadecanethiol, n-heptadecanethiol, n-octadecanethiol, n-nonadecanethiol, n-eicosanethiol, n-docosanethiol. Particular preference is given to linear, even-number alkanethiols

The alkanethiols may also be used in mixtures.

The alkanethiols are usually used in amounts of from 0.1 to 5% by weight, in particular 0.25 to 2% by weight, based on the monomers to be polymerized. The alkanethiols are usually added to the polymerization together with the monomers.

### Hydrogen Peroxide Treatment

If, in the polymerization, alkanethiols with a carbon chain length of from C₁₀ to C₁₃ are used, a subsequent hydrogen peroxide treatment is required in order to obtain polymers with a neutral odor. For this hydrogen peroxide treatment which follows the polymerization, use is usually made of from 0.01 to 2.0% by weight, in particular 0.02 to 1.0% by weight, preferably 0.3 to 0.8% by weight, further preferably 0.03 to 0.15% by weight, of hydrogen peroxide, based upon the monomers to be polymerized. It has proven advantageous to carry out the hydrogen peroxide treatment at a temperature of from 20 to 100° C., in particular from 30 to 80° C. The hydrogen peroxide treatment is usually carried out for a period from 30 min to 240 min, in particular from 45 min to 90 min.

If alkanethiols with a carbon chain length of from C₁₄ to C₂₂ are used, the hydrogen peroxide treatment can be omitted. In a further embodiment of the invention, however, a hydrogen peroxide treatment may follow even when using alkanethiols with a chain length of from C₁₄ to C₂₂.

### K Value

The polymers according to the invention have K values between 27 and 38. In a preferred embodiment, the K value of the polymers according to the invention is in the range from 29 to 35, particularly preferably in the range from 30 to 34 and very particularly preferably in the range from 30 to 32. The K value desired in each case can be adjusted through choice of the polymerization conditions, for example the polymerization temperature and the initiator concentration.

In a preferred embodiment, regulators are used to adjust the K value, in particular when using emulsion and suspension polymerization.

The K value can be adjusted through the choice of the type and/or the amount of regulator. In a preferred embodiment, lower K values are established by relatively large amounts of regulator based on the total amount of monomer.

### Glass Transition Temperature

The monomers C, which are used, if appropriate, for the preparation of the polymers according to the invention, are chosen such that at least one of the monomers C produces a homopolymer with a glass transition temperature of less than 30° C.

The polymers according to the invention usually have glass transition temperatures T_{g} between 50 and 130° C., in particular between 60 and 100° C.

The glass transition temperature T_{g} is the limit of the glass transition temperature to which, according to G. Kanig (Kolloid-Zeitschrift & Zeitschrift für Polymere, Vol. 190, page 1, equation 1) the glass transition temperature tends with increasing molecular weight. The glass transition temperature is determined by the DSC method (differential scanning calorimetry, 20 K/min, midpoint measurement, DIN 53 765).

The T_{g} values for the homopolymers of the abovementioned monomers are known and are stated, for example, in Ullmann's Encyclopedia of Industrial Chemistry, Verlag Chemie, Weinheim, 1992, 5^{th} edition, Vol. A21, page 169; other sources of glass transition temperatures of homopolymers are, for example, J. Brandrup, E. H. Immergut, Polymer Handbook, 1st Ed., J. Wiley, New York 1966, 2nd Ed. J. Wiley, New York 1975, and 3rd Ed. J. Wiley, New York 1989).

According to Fox (T. G. Fox, Bull. Am. Phys. Soc. 1956 [Ser. II] 1, page 123 and according to Ullmann's Encyclopedia of Industrial Chemistry, Vol. 19, page 18, 4^{th} edition, Verlag Chemie, Weinheim, 1980) a good approximation for the glass transition temperature of at most weakly crosslinked copolymers is:

1/T_{g}=x1/T_{g}1+x2/T_{g}2+ . . . xn/T_{g}n,

where x1, x2, . . . xn are the mass fractions of the monomers 1, 2, . . . n and T_{g} 1, T_{g} 2, . . . T_{g} n are the glass transition temperatures, degrees Kelvin, of the polymers composed only of one of the monomers 1, 2, . . . n.

### Carrying Out the Emulsion Polymerization

The emulsion polymerization usually takes place with the exclusion of oxygen, for example under a nitrogen or argon atmosphere, at temperatures in the range from 20 to 200° C. Polymerization temperatures in the range from 50 to 130° C., in particular 70 to 95° C., are advantageous.

In the case of free-radically initiated emulsion polymerization, in order to avoid coagulation, it is to be ensured, particularly at relatively high temperatures, that the polymerization mixture does not boil. This may be avoided, for example, by carrying out the polymerization reaction at an inert gas pressure which is higher than the vapor pressure of the polymerization mixture, for example 1.2 bar, 1.5 bar, 2 bar, 3 bar, 5 bar, 10 bar or even higher (in each case absolute values). The polymerization can be carried out batchwise, semicontinuously or continuously. The polymerization and the monomer and regulator feed are often carried out semicontinuously by the feed method.

The amounts of monomers and dispersant are expediently chosen such that a 30 to 80% strength by weight dispersion of the copolymers is comprised. Preferably, at least some of the monomers, initiators and, if appropriate, regulators are metered into the reaction vessel uniformly throughout the polymerization. However, it is also possible to have an initial charge of the monomers and the initiator in the reactor and to polymerize them, with cooling if appropriate.

According to a preferred embodiment, the polymerization is carried out using a seed latex. The seed latex is expediently prepared from the polymers to be polymerized in the first polymerization phase in the customary manner. The remainder of the monomer mixture is added, preferably by the feed method.

The polymerization reaction advantageously takes place until the monomer conversion is >95% by weight, preferably >98% by weight or >99% by weight.

It is often useful if the aqueous polymer dispersion obtained is subjected to an after-polymerization step in order to reduce further the amount of unreacted monomer. This measure is known to the person skilled in the art (for example EP-B 3957, EP-B 28348, EP-B 563726, EP-A 764699, EP-A 767180, DE-A 3718520, DE-A 3834734, DE-A4232194, DE-A 19529599, DE-A 19741187, DE-A 19839199, DE-A 19840586, WO 95/33775 or U.S. Pat. No. 4,529,753).

### Processing the Dispersions

The aqueous polymer dispersions obtainable according to the invention can be dried to give redispersible polymer powders in a simple manner.

If the polymer is prepared by emulsion polymerization, the dispersion obtained can either be incorporated directly into an aqueous, aqueous-alcoholic or alcoholic cosmetic preparation, for example a hair-setting preparation, or drying of the dispersion takes place, e.g. spray-drying or freeze-drying, so that the polymer can be used and processed in the form of powder.

It is of course also possible to subject the aqueous polymer dispersion obtained to an inert-gas and/or steam stripping, likewise known to the person skilled in the art, before or after the after-polymerization step. This stripping operation preferably takes place after the after-polymerization step. As is described in EP-A 805169, partial neutralization of the dispersion to a pH in the range from 5 to 7, preferably to a pH in the range from 5.5 to 6.5, is advantageous before the physical deodorization.

### Neutralization

Moreover, the polymers present in aqueous dispersion in the before or after the after-treatment can be partially or completely neutralized. For using the polymers in hair cosmetic preparations in particular, partial or complete neutralization of the polymer dispersions is advantageous.

The polymers are usually partially or completely neutralized, expediently to 5 to 100%, or often to 30 to 95%, using an alkali metal hydroxide or preferably using an amine. In a preferred embodiment, the polymers are partially neutralized, and in a particularly preferred embodiment completely neutralized.

The neutralization is advantageously carried out with
a mono-, di- or trialkanolamine having 2 to 5 carbon atoms in the alkanol radical, which is present in etherified form if appropriate, for example mono-, di- and triethanolamine, mono-, di- and tri-n-propanolamine, mono-, di- and triiso-propanolamine, 2-amino-2-methylpropanol and di(2-methoxyethyl)amine,
an alkanediolamine having 2 to 5 carbon atoms, for example 2-amino-2-methylpropane-1,3-diol and 2-amino-2-ethylpropane-1,3-diol, or
a primary, secondary or tertiary alkylamine having a total of 5 to 10 carbon atoms, for example N,N-diethylpropylamine or 3-diethylamino-1-propylamine.

Good neutralization results are often obtained with 2-amino-2-methylpropanol, triiso-propanolamine, 2-amino-2-ethylpropane-1,3-diol or 3-diethylamino-1-propylamine.

Suitable alkali metal hydroxides for the neutralization are primarily sodium hydroxide, or potassium hydroxide and ammonium hydroxide.

Also suitable for the neutralization are aqueous buffer solutions, such as, for example, buffers based on alkali metal or ammonium carbonate or bicarbonate.

The neutralizing agents are preferably added in the form of a dilute aqueous solution to the polymer dispersion.

The pH can, if appropriate, also be adjusted by adding a buffer solution, preference being given to buffers based on alkali metal or ammonium carbonate or hydrogen carbonate.

### Determination of the Particle Size

The polymer particles present in aqueous dispersion generally have a weight-average particle diameter>5 nm, >10 nm, >20 nm, >30 nm, >40 nm, >50 nm, >60 nm, >70 nm, >80 nm, >90 nm or >100 nm and all values inbetween, and <700 nm, <500 nm, <400 nm, <350 nm, <300 nm, <250 nm, <200 nm, <150 nm, <100 nm, <90 nm, <80 nm, <70 nm, <60 nm, <50 nm or <40 nm and all values inbetween. Determination of the weight-average particle diameter is known to the person skilled in the art and takes place, for example, by means of the analytical ultracentrifugation method. In this specification, weight-average particle diameter is understood as meaning the weight-average D_{w50} value determined by the analytical ultracentrifugation method (cf. for this S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC Multiplexer: High Resolution Particle Size Distribution and Density Gradient Techniques, W. Mächtle, pages 147 to 175).

The polymer solids content of the aqueous polymer dispersions accessible according to the invention is frequently 5 to 70% by weight, often 20 to 60% by weight, or 30 to 60% by weight.

### Use of the Polymers

The (meth)acrylate polymers according to the invention are used in cosmetic, hygiene, dermatological and/or pharmaceutical preparations, which are prepared in accordance with customary rules familiar to the person skilled in the art. The (meth)acrylate polymers according to the invention are preferably used in cosmetic preparations, particularly preferably in hair cosmetic preparations. The (meth)acrylate polymers according to the invention are also preferably used in preparations for oral care and dental care.

The (meth)acrylate polymers according to the invention are characterized by excellent film-forming properties. The invention thus further provides the use of the (meth)acrylate polymers as film formers.

For use in cosmetic preparations, the (meth)acrylate polymers present in partially or completely neutralized form are particularly suitable.

### Cosmetic Preparations

The (meth)acrylate polymers according to the invention may be present in cosmetic preparations in the form of aqueous or aqueous-alcoholic solutions, O/W and W/O emulsions in the form of shampoos, creams, foams, sprays (pump spray or aerosol), gels, gel sprays, lotions or mousse and accordingly be formulated with customary further auxiliaries.

The (meth)acrylate polymers according to the invention are preferably formulated in cosmetic preparations as sprays (pump spray or aerosol). They are particularly preferably provided as VOC-55 formulations.

### Additives

Besides the (meth)acrylate polymers according to the invention and suitable solvents, the cosmetic, dermatological, hygiene and/or pharmaceutical preparations can also comprise additives customary in such formulations, such as emulsifiers and coemulsifiers, surfactants, oil bodies, preservatives, perfume oils, cosmetic care substances and active ingredients, such as AHA acids, fruit acids, ceramides, phytantriol, collagen, vitamins and provitamins, for example vitamin A, E and C, retinol, bisabolol, panthenol, natural and synthetic photoprotective agents, natural substances, opacifiers, solubility promoters, repellants, bleaches, colorants, tints, tanning agents (e.g. dihydroxyacetone), micropigments, such as titanium oxide or zinc oxide, superfatting agents, pearlescent waxes, bodying agents, thickeners, solubilizers, complexing agents, fats, waxes, silicone compounds, hydrotropic agents, dyes, stabilizers, pH regulators, reflectors, proteins and protein hydrolyzates (e.g. wheat, almond or pea proteins), ceramide, protein hydrolyzates, salts, gel formers, bodying agents, silicones, humectants, refatting agents and further customary additives. Furthermore, to establish the properties desired in each case, in particular, further polymers may also be present. To protect the skin and the hair from adverse effects as a result of UV radiation, UV photoprotective agents may also be present in the cosmetic preparations. The auxiliaries may be present during the polymerization and/or be added after the polymerization.

Examples of the particular classes of auxiliaries are mentioned below, without the possible auxiliaries being limited to those specified by way of example.

The invention accordingly further provides the use of the polymers according to the invention in cosmetic and/or pharmaceutical preparations.

### UV Photoprotection

The photoprotective filters used in cosmetic and pharmaceutical preparations have the task of preventing harmful effects of sunlight on the human skin, or at least of reducing their consequences. In addition, however, these photoprotective filters also serve to protect further ingredients against decomposition or degradation by UV radiation. In hair cosmetic formulations the aim is to prevent damage to keratin fibers as a result of UV rays.

The sunlight which reaches the surface of the earth has a fraction of UV-B radiation (280 to 320 nm) and of UV-A radiation (320 to 400 nm) which directly border the visible light region. The effect on the human skin is evident particularly in the case of UV-B radiation through sunburn.

The maximum of the erythema activity of sunlight is given as the relatively narrow range around 308 nm.

To protect against UV-B radiation, numerous compounds are known, which are, inter alia, derivatives of 3-benzylidenecamphor, of 4-aminobenzoic acid, of cinnamic acid, of salicylic acid, of benzophenone, and of 2-phenylbenzimidazole.

It is also important to have available filter substances for the range between about 320 nm and about 400 nm, the so-called UV-A region, since its rays can cause reactions in photosensitive skin. It has been found that UV-A radiation leads to damage of the elastic and collagenous fibers of connective tissue, which causes the skin to age prematurely, and that it should be regarded as the cause of numerous phototoxic and photoallergic reactions. The harmful effect of UV-B radiation can also be intensified by UV-A radiation.

UV photoprotective filters which may be used are oil-soluble organic UV-A filters and/or UV-B filters and/or water-soluble organic UV-A filters and/or UV-B filters. The total amount of UV photoprotective filters is generally 0.1% by weight to 30% by weight, preferably 0.5 to 15% by weight, in particular 1 to 10% by weight, based on the total weight of the preparation.

The UV photoprotective filters are advantageously chosen such that the preparations protect the skin from the entire range of ultraviolet radiation.

Examples of UV photoprotective filters are:

| No. | Substance | CAS No. |
|---|---|---|
| 1 | 4-Aminobenzoic acid | 150-13-0 |
| 2 | 3-(4′-Trimethylammonium)benzylidenebornan- | 52793-97-2 |
| | 2-one methylsulfate | |
| 3 | 3,3,5-Trimethylcyclohexyl salicylate (homosalate) | 118-56-9 |
| 4 | 2-Hydroxy-4-methoxybenzophenone (oxybenzone) | 131-57-7 |
| 5 | 2-Phenylbenzimidazole-5-sulfonic acid and its | 27503-81-7 |
| | potassium, sodium and triethanolamine salts | |
| 6 | 3,3′-(1,4-Phenylenedimethine)bis(7,7-dimethyl-2- | 90457-82-2 |
| | oxobi-cyclo[2.2.1]heptane-1-methanesulfonic acid) | |
| | and its salts | |
| 7 | Polyethoxy ethyl 4-bis(polyethoxy)aminobenzoate | 113010-52-9 |
| 8 | 2-Ethylhexyl 4-dimethylaminobenzoate | 21245-02-3 |
| 9 | 2-Ethylhexyl salicylate | 118-60-5 |
| 10 | 2-Isoamyl 4-methoxycinnamate | 71617-10-2 |
| 11 | 2-Ethylhexyl 4-methoxycinnamate | 5466-77-3 |
| 12 | 2-Hydroxy-4-methoxybenzophenone-5-sulfonic acid | 4065-45-6 |
| | (sulisobenzone) and the sodium salt | |
| 13 | 3-(4′-Sulfo)benzylidenebornan-2-one and salts | 58030-58-6 |
| 14 | 3-Benzylidenebornan-2-one | 16087-24-8 |
| 15 | 1-(4′-Isopropylphenyl)-3-phenylpropane-1,3-dione | 63260-25-9 |
| 16 | 4-Isopropylbenzyl salicylate | 94134-93-7 |
| 17 | 2,4,6-Trianilino(o-carbo-2′-ethylhexyl-1′-oxy)-1,3,5- | 88122-99-0 |
| | triazine | |
| 18 | 3-Imidazol-4-ylacrylic acid and its ethyl ester | 104-98-3 |
| 19 | Menthyl o-aminobenzoate or: 5-methyl-2-(1- | 134-09-8 |
| | methylethyl)-2-aminobenzoate | |
| 20 | Glyceryl p-aminobenzoate or 1-glyceryl 4- | 136-44-7 |
| | aminobenzoate | |
| 21 | 2,2′-Dihydroxy-4-methoxybenzophenone | 131-53-3 |
| | (dioxybenzone) | |
| 22 | 2-Hydroxy-4-methoxy-4-methylbenzophenone | 1641-17-4 |
| | (mexenone) | |
| 23 | Triethanolamine salicylate | 2174-16-5 |
| 24 | Dimethoxyphenylglyoxalic acid or: sodium 3,4- | 4732-70-1 |
| | dimethoxy-phenylglyoxalate | |
| 25 | 3-(4′Sulfo)benzylidenebornan-2-one and its salts | 56039-58-8 |
| 26 | 2,2′,4,4′-Tetrahydroxybenzophenone | 131-55-5 |
| 27 | 2,2′-Methylenebis[6(2H-benzotriazol-2-yl)-4- | 103597-45-1 |
| | (1,1,3,3-tetramethylbutyl)phenol] | |
| 28 | 2,2′-(1,4-Phenylene)bis-1H-benzimidazole-4,6- | 180898-37-7 |
| | disulfonic acid, Na salt | |
| 29 | 2,4-bis-[4-(2-Ethylhexyloxy)-2-hydroxy]phenyl- | 187393-00-6 |
| | 6-(4-methoxyphenyl)-(1,3,5)-triazine | |
| 30 | 3-(4-Methylbenzylidene)camphor | 36861-47-9 |
| 31 | Polyethoxyethyl 4-bis(polyethoxy)paraamino- | 113010-52-9 |
| | benzoate | |
| 32 | 2,4-Dihydroxybenzophenone | 131-56-6 |
| 33 | 2,2′-Dihydroxy-4,4′-dimethoxybenzo- | 3121-60-6 |
| | phenone-5,5′-disodium sulfonate | |

Further photoprotective agents which can be combined are, inter alia, the following compounds:

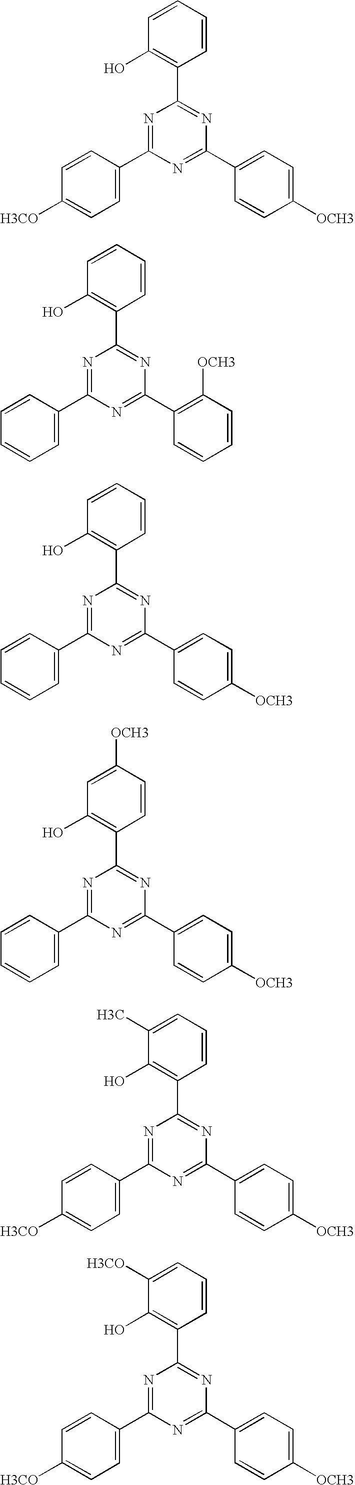

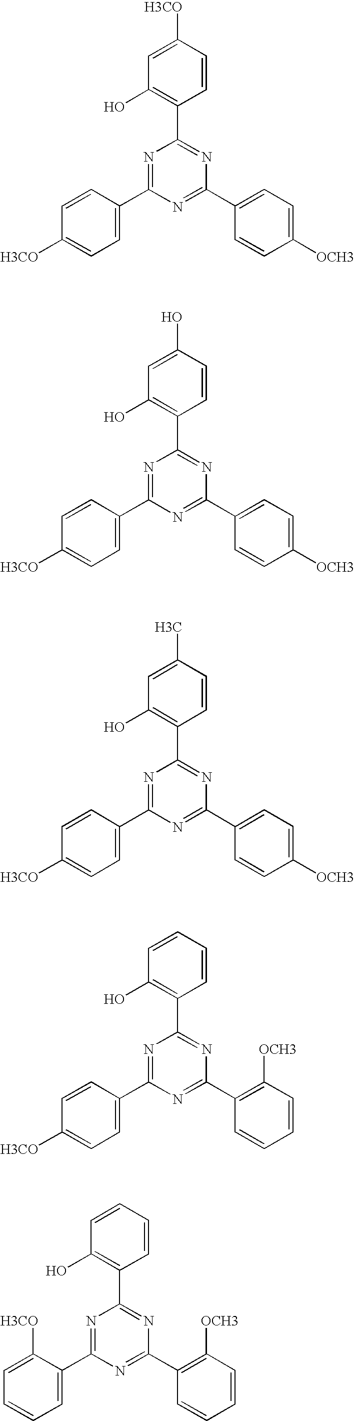

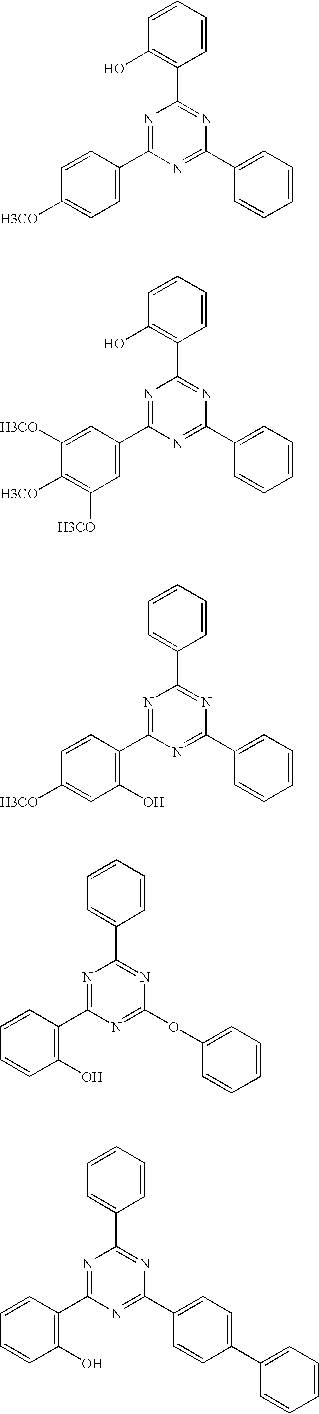

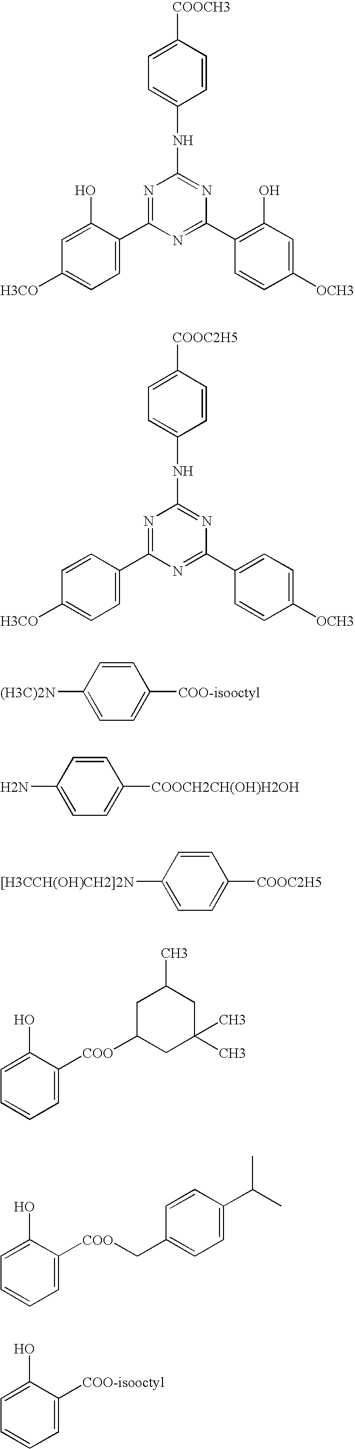

The list of specified UV photoprotective filters which can be used in combination with the polymers according to the invention is not of course intended to be limiting.

### Antibacterial Agents

In addition, antibacterial agents can also be used. These generally include all suitable preservatives with a specific action against gram-positive bacteria, e.g. triclosan (2,4,4′-trichloro-2′-hydroxydiphenyl ether), chlorhexidine (1,1′-hexamethylenebis[5-(4-chlorophenyl)biguanide) and TTC (3,4,4′-trichlorocarbanilide).

Quaternary ammonium compounds are in principle likewise suitable, but are used preferably for disinfecting soaps and washing lotions.

Numerous fragrances also have antimicrobial properties. Specific combinations having particular effectiveness against gram-positive bacteria are used for the composition of so-called deodorant perfumes.

Also, a large number of essential oils or characteristic ingredients thereof, such as, for example, oil of cloves (eugenol), mint oil (menthol) or thyme oil (thymol), exhibit marked antimicrobial effectiveness.

The antibacterially effective substances are generally used in concentrations of from about 0.1 to 0.3% by weight.

### Skin Cosmetic Preparations

Cosmetic preparations which may be specified are, for example, skin cosmetic preparations, in particular those for the care and/or cleansing of the skin. These are present particularly in the form of W/O or O/W skin creams, day and night creams, eye creams, face creams, antiwrinkle creams, mimic creams, moisturizing creams, bleaching creams, vitamin creams, skin lotions, care lotions and moisturizing lotions. They are also suitable for skin cosmetic preparations such as face tonics, face masks, deodorants and other cosmetic lotions and for use in decorative cosmetics, for example as concealing stick, stage makeup, in mascara and eye shadows, lipsticks, kohl pencils, eyeliners, makeup, foundations, blushers and powders and eyebrow pencils.

Furthermore, the (meth)acrylate polymers according to the invention can be used in nose strips for pore cleansing, in antiacne constituents, repellents, shaving compositions, depilatories, personal hygiene compositions, foot care compositions, and in baby care.

In addition, the polymers according to the invention are used as or in (a) coating(s) for keratin-containing and keratin-analogous surfaces, such as hair, skin and nails.

For example, the polymers according to the invention are also used in cosmetic compositions for cleansing skin. Such cosmetic cleansing compositions are, for example, bar soaps, such as toilet soaps, curd soaps, transparent soaps, luxury soaps, deodorant soaps, cream soaps, baby soaps, skin protection soaps, abrasive soaps and syndets, liquid soaps, such as pasty soaps, soft soaps and washing pastes, and liquid washing, shower and bath preparations, such as washing lotions, shower baths and gels, foams baths, oil baths and scrub preparations, and shaving foams, lotions and creams.

Depending on the field of use, the compositions according to the invention can be applied in a form suitable for skincare, e.g. as cream, foam, gel, stick, mousse, milk, spray or lotion. Particular preference is given to use in the form of a gel, in particular in the form of a clear gel.

Besides the polymers according to the invention and suitable carriers, the skin cosmetic preparations may also comprise further active ingredients and auxiliaries customary in skin cosmetics, as described above. These preferably include emulsifiers, preservatives, perfume oils, cosmetic active ingredients, such as phytantriol, vitamin A, E and C, retinol, bisabolol, panthenol, natural and synthetic photoprotective agents, bleaches, colorants, tinting agents, tanning agents, collagen, protein hydrolyzates, stabilizers, pH regulators, dyes, salts, thickeners, gelling agents, bodying agents, silicones, humectants, refatting agents and further customary additives.

Preferred oil and fat components of the skin cosmetic and dermatological compositions are the abovementioned mineral and synthetic oils, such as, for example, paraffins, silicone oils and aliphatic hydrocarbons having more than 8 carbon atoms, animal and vegetable oils, such as, for example, sunflower oil, coconut oil, avocado oil, olive oil, lanolin, or waxes, fatty acids, fatty acid esters, such as, for example, 6. triglycerides of C₆-C₃₀-fatty acids, wax esters, such as, for example, jojoba oil, fatty alcohols, vaseline, hydrogenated lanolin and acetylated lanolin, and mixtures thereof.

The polymers according to the invention can also be mixed with conventional polymers if specific properties are to be set. To set certain properties, such as, for example, improving the feel to the touch, the spreading behavior, the water resistance and/or the binding of active ingredients and auxiliaries such as pigments, the skin cosmetic and dermatological preparations may additionally also comprise conditioning substances based on silicone compounds. Suitable silicone compounds are, for example, polyalkylsiloxanes, polyarylsiloxanes, polyarylalkylsiloxanes, polyethersiloxanes or silicone resins.

The cosmetic or dermatological preparations are prepared by customary processes known to the person skilled in the art.

The cosmetic and dermatological compositions are preferably in the form of emulsions, in particular in the form of water-in-oil (W/O) or oil-in-water (O/W) emulsions. It is, however, also possible to choose other formulation types, for example hydro-dispersions, gels, oils, oleogels, multiple emulsions, for example in the form of W/O/W or O/W/O emulsions, anhydrous ointments or ointment bases, etc.

The preparation of emulsions takes place by known methods. Besides the polymers according to the invention, the emulsions generally comprise customary constituents, such as fatty alcohols, fatty acid esters and, in particular, fatty acid triglycerides, fatty acids, lanolin and derivatives thereof, natural or synthetic oils or waxes and emulsifiers in the presence of water. The choice of the additives specific to the type of emulsion and the preparation of suitable emulsions is described, for example, in Schrader, Grundlagen und Rezepturen der Kosmetika [Fundamentals and Formulations of Cosmetics], Hüthig Buch Verlag, Heidelberg, 2^{nd} edition, 1989, third part, which is herein expressly incorporated by reference.

A suitable emulsion, e.g. for a skin cream etc., generally comprises an aqueous phase which is emulsified into an oil or fatty phase using a suitable emulsifier system. The fraction of the emulsifier system in this type of emulsion is preferably about 4 to 35% by weight, based on the total weight of the emulsion. The proportion of the fatty phase is about 20 to 60% by weight. Preferably, the proportion of the aqueous phase is about 20 to 70%, in each case based on the total weight of the emulsion. The emulsifiers are those which are customarily used in this type of emulsion. They are chosen, for example, from C₁₂-C₁₈-sorbitan fatty acid esters, esters of hydroxystearic acid and C₁₂-C₃₀-fatty alcohols, mono- and diesters of C₁₂-C₁₈-fatty acids and glycerol or polyglycerol, condensates of ethylene oxide and propylene glycols, oxypropylenated/oxyethylated C₁₂-C₁₈-fatty alcohols, polycyclic alcohols, such as sterols, aliphatic alcohols with a high molecular weight, such as lanolin, mixtures of oxypropylenated/polyglycerolated alcohols and magnesium isostearate; succinic esters of polyoxyethylenated or polyoxypropylenated fatty alcohols and mixtures of magnesium, calcium, lithium, zinc or aluminum lanolate and hydrogenated lanolin or lanolin alcohol.

Preferred fatty components which may be present in the fatty phase of the emulsions are hydrocarbon oils, such as, for example, paraffin oil, purcellin oil, perhydrosqualene and solutions of microcrystalline waxes in these oils, animal or vegetable oils, such as, for example, sweet almond oil, avocado oil, calophylum oil, lanolin and derivatives thereof, castor oil, sesame oil, olive oil, jojoba oil, carite oil, hoplostethus oil, mineral oils whose distillation start-point under atmospheric pressure is about 250° C. and whose distillation end-point is about 410° C., such as, for example, Vaseline oil, esters of saturated or unsaturated fatty acids, such as, for example, alkyl myristates, e.g. isopropyl, butyl or cetyl myristate, hexadecyl stearate, ethyl or iso-propyl palmitate, octanoic or decanoic acid triglycerides and cetyl ricinoleate.

The fatty phase can also comprise silicone oils which are soluble in other oils, such as, for example, dimethylpolysiloxane, methylphenylpolysiloxane and the silicone glycol copolymer, fatty acids and fatty alcohols.

In order to favor the retention of oils, besides the polymers according to the invention, it is also possible to use waxes, such as, for example, carnauba wax, candelilla wax, beeswax, microcrystalline wax, ozokerite wax and Ca, Mg and Al oleates, myristates, linoleates and stearates.

In general, the water-in-oil emulsions are prepared by adding the fatty phase and the emulsifiers to a mixing container. The latter is heated at a temperature of from about 50 to 75° C., then the oil-soluble active ingredients and/or auxiliaries are added, and water which has been heated beforehand to approximately the same temperature and into which, if appropriate, the water-soluble ingredients have been dissolved beforehand is added with stirring. The mixture is stirred until an emulsion of the desired fineness is obtained and then left to cool to room temperature, if appropriate with gentle stirring.

According to a further preferred embodiment, the compositions according to the invention are a shower gel, a shampoo formulation or a bath preparation. Preference is given to show gels, in particular clear show gels. Such formulations comprise at least one polymer according to the invention, and usually anionic surfactants as base surfactants and amphoteric and/or nonionic surfactants as cosurfactants. Further suitable active ingredients and/or auxiliaries are customarily chosen from lipids, perfume oils, dyes, organic acids, preservatives and antioxidants, and thickeners, gel formers, skin conditioning agents and humectants.

These formulations preferably comprise about 2 to 50% by weight, preferably 5 to 40% by weight, particularly preferably 8 to 30% by weight, of surfactants, based on the total weight of the formulation.

All anionic, neutral, amphoteric or cationic surfactants customarily used in body cleansing compositions can be used in the washing, shower and bath preparations.

Suitable anionic surfactants are, for example, alkyl sulfates, alkyl ether sulfates, alkylsulfonates, alkylarylsulfonates, alkyl succinates, alkyl sulfosuccinates, N-alkoyl sarcosinates, acyl taurates, acyl isothionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts.

The alkyl ether sulfates, alkyl ether phosphates and alkyl ether carboxylates can have between 1 and 10 ethylene oxide and propylene oxide units, preferably 1 to 3 ethylene oxide units, in the molecule.

These include, for example, sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate.

Suitable amphoteric surfactants are, for example, alkylbetaines, alkylamidopropylbetaines, alkylsulfobetaines, alkyl glycinates, alkyl carboxyglycinates, alkyl amphoacetates or propionates, alkyl amphodiacetates or dipropionates.

For example, cocodimethylsulfopropylbetaine, laurylbetaine, cocamidopropylbetaine or sodium cocamphopropionate can be used.

Suitable nonionic surfactants are, for example, the reaction products of aliphatic alcohols or alkylphenols with 6 to 20 carbon atoms in the alkyl chain, which may be linear or branched, with ethylene oxide and/or propylene oxide. The amount of alkylene oxide is about 6 to 60 mol per mole of alcohol. Also suitable are alkylamine oxides, mono- or dialkylalkanolamides, fatty acid esters of polyethylene glycols, ethoxylated fatty acid amides, alkyl polyglycosides or sorbitan ether esters.

In addition, the washing, shower and bath preparations can comprise customary cationic surfactants, such as, for example, quaternary ammonium compounds, for example cetyltrimethylammonium chloride.

In addition, further customary cationic polymers may also be used, thus, for example, copolymers of acrylamide and dimethyldiallylammonium chloride (polyquaternium-7), cationic cellulose derivatives (polyquaternium-4, polyquaternium-10), guar hydroxypropyltrimethylammonium chloride (INCI: Hydroxypropyl Guar Hydroxypropyl-trimonium Chloride), copolymers of N-vinylpyrrolidone and quaternized N-vinylimidazole (polyquaternium-16, -44, -46), copolymers of N-vinylpyrrolidone/di-methylaminoethyl methacrylate, quaternized with diethyl sulfate (polyquaternium-11) and others.

The shower gel/shampoo formulations can also comprise thickeners, such as, for example, sodium chloride, PEG-55, propylene glycol oleate, PEG-120 methyl glucose dioleate and others, and also preservatives, further active ingredients and auxiliaries, and water.

### Hair Cosmetic Preparations

Particular preference is given to the use of the (meth)acrylate polymers in hair cosmetic preparations. Hair cosmetic preparations which may be mentioned are hair treatments, hair lotions, hair rinses, hair emulsions, end fluids, neutralizing agents for permanent waves, hot-oil treatment preparations, conditioners, curl relaxers, styling wrap lotions, setting lotions, shampoos, hair waxes, pomades, hair mousses, hair colorants or hairsprays. Particular preference is given to the use of the (meth)acrylate polymers in hairstyle-setting compositions which are in the form of spray preparations and/or hair mousses.

The (meth)acrylate polymers according to the invention are characterized in hair cosmetic preparations by their good compatibility with the nonpolar propellants in spray preparations, in particular with hydrocarbons such as n-propane, isopropane, n-butane, isobutane, n-pentane and mixtures thereof and in particular by the excellent sprayability as pump spray or aerosol.

They are also very readily compatible with other additives customary in hair cosmetics, have a good hair-setting action, form films with very good mechanical properties and are characterized in that they cause virtually no sticking-together of the hair.

Besides the freedom from odor, the (meth)acrylate polymers have excellent results for the application properties in hair cosmetic preparations. They dissolve in alcohols such as ethanol or isopropanol and in mixtures of these alcohols with water to form clear solutions. The clarity of the solutions is also obtained when the solutions are used in standard spray formulations together with propellants such as dimethyl ether. In particular, they can be formulated in aqueous low-VOC preparations with at most 55% by weight of volatile organic constituents (VOC-55) to give clear mixtures.

The hair-setting compositions according to the invention can be washed out of the hair without problems. Hair treated therewith has increased softness and a pleasant natural feel. The setting action is also good, making it possible, in principle, to reduce the required amount of film former in the hairspray formulation. Due to the fact that the (meth)acrylate polymers are free from odor, it is possible, as required, to dispense with an addition of odor-concealing perfume oils. For the reasons given, the (meth)acrylate polymers are suitable in particular as film formers in hair cosmetic preparations.

The (meth)acrylate polymers are usually used in 0.1 to 20% by weight, preferably 0.5 to 10% by weight, in particular 2 to 10% by weight, of the partially or completely neutralized (meth)acrylate polymer, based on the cosmetic preparation.

### Hairspray Formulations

Preference is given to the use of the (meth)acrylate polymers in cosmetic preparations, in particular in hairspray preparations, which comprise the following constituents:
0.1 to 20% by weight, preferably 0.5 to 15% by weight, in particular 1 to 10% by weight of the partially or completely neutralized (meth)acrylate polymer
0 to 99.9% by weight, preferably 1 to 50% by weight, in particular 10 to 20% by weight, of water
0 to 95% by weight, preferably 20 to 60% by weight, in particular 25 to 50% by weight, of a customary organic solvent, such as, in particular, ethanol, isopropanol and dimethoxymethane and also acetone, n-propanol, n-butanol, 2-methoxypropan-1-ol, n-pentane, n-hexane, cyclohexane, n-heptane, n-octane or dichloromethane or mixtures thereof
0 to 90% by weight, preferably 30 to 80% by weight, in particular 45 to 60% by weight, of a customary propellant, such as n-propane, isopropane, n-butane, isobutane, 2,2-dimethylbutane, n-pentane, isopentane, dimethyl ether, difluoroethane, fluorotrichloromethane, dichlorodifluoromethane or dichlorotetrafluoroethane, HFC 152 A or mixtures thereof.

Alkanolamines are used for the neutralization of various types of acids and to establish the pH of cosmetic products. Examples (INCI) are Aminomethyl Propanol, Diethanolamine, Diisopropanolamine, Ethanolamine, Methylethanolamine, N-Lauryl Diethanolamine, Triethanolamine, Triisoproanolamine, etc. It is also possible to use alkali metal hydroxides (e.g. NaOH, KOH) and other bases for the neutralization (e.g. histidine, arginine, lysine or ethylenediamines, diethylenetriamine, melamine, benzoguanamine). All of the bases given can be used on their own or in a mixture with other bases to neutralize acid-containing cosmetic products.

### Propellants (Propellant Gases)

Of said compounds, the propellants (propellant gases) primarily used are the hydrocarbons, in particular propane, n-butane, n-pentane and mixtures thereof and also dimethyl ether and difluoroethane. If appropriate, one or more of said chlorinated hydrocarbons are co-used in propellant mixtures, but only in small amounts, for example up to 20% by weight, based on the propellant mixture.

The hair cosmetic preparations according to the invention are also particularly suitable for pump spray preparations without the addition of propellants, or else for aerosol sprays with customary compressed gases, such as nitrogen, compressed air or carbon dioxide as propellant.

A hydrous standard spray formulation has, for example, the following composition:
2 to 10% by weight of the (meth)acrylate polymer neutralized to 100% with 2-amino-2-methylpropanol
10 to 76% by weight of ethanol
2 to 20% by weight of water
10 to 60% by weight of dimethyl ether and/or propane/n-butane and/or propane/isobutane.

### Further Polymers

To set specific properties of cosmetic, in particular skincare and haircare, preparations, it may be advantageous to use the (meth)acrylate polymers according to the invention in the form of a mixture with further polymers. Suitable conventional polymers for this purpose are, for example, anionic, cationic, amphoteric and neutral polymers.

Preferred examples of such further polymers are
copolymers of ethyl acrylate and methacrylic acid
copolymers of N-tert-butylacrylamide, ethyl acrylate and acrylic acid
polyvinylpyrrolidones
polyvinylcaprolactams
polyurethanes
copolymers of acrylic acid, methyl methacrylate, octylacrylamide, butylaminoethyl methylacrylate and hydroxypropyl methacrylate,
copolymers of vinyl acetate and crotonic acid and/or (vinyl) neodecanoate,
copolymers of vinyl acetate and/or vinyl propionate and N-vinylpyrrolidone,
carboxy functional copolymers of vinylpyrrolidone, t-butyl acrylate, methacrylic acid,
copolymers of tert-butyl acrylate, methacrylic acid and dimethicone copolyol.

Surprisingly, it has been found that preparations which comprise the polymers in combination with these further polymers have unexpected properties. The preparations according to the invention are superior to the preparations of the prior art particularly with regard to their skincare and haircare properties. In addition, they have very good film-forming and setting properties.

Copolymers of ethyl acrylate and methacrylic acid (INCI name: Acrylates Copolymer) are available, for example, as commercial products Luviflex™ Soft (BASF).

Copolymers of N-tert-butylacrylamide, ethyl acrylate and acrylic acid (INCI name: Acrylates/Acrylamide Copolymer) are available, for example, as commercial products Ultrahold Strong™, Ultrahold 8™ (BASF).

Polyvinylpyrrolidones (INCI name: PVP) are available, for example, under the trade name Luviskol K™, Luviskol K 30™ (BASF) and PVP K (ISP).

Polyvinylcaprolactams (INCI: Polyvinylcaprolactams) are available, for example, under the trade name Luviskol Plus™ (BASF).

Polyurethanes (INCI: Polyurethane-1) are available, for example, under the trade name Luviset™ PUR.

Copolymers of acrylic acid, methyl methacrylate, octylacrylamide, butylaminoethyl methylacrylate, hydroxypropyl methacrylate (INCI: Octylacrylamide/Acrylates/Butyl-aminoethyl Methacrylate Copolymer) are known, for example, under the trade names Amphomer™ 28-4910 and Amphomer™ LV-71 (National Starch).

Copolymers of vinyl acetate and crotonic acid (INCI: VA/Crotonate/Copolymer) are available, for example, under the trade names Luviset CA 66™ (BASF), Resyn™ 28-1310 (National Starch) and Aristoflex™ A (Celanese).

Copolymers of vinyl acetate, crotonic acid and (vinyl) neodecanoate (INCI: VA/Crotonates/Neodecanoate Copolymer) are available, for example, under the trade names Resyn™ 28-2930 (National Starch) and Luviset™ CAN (BASF).

Copolymers of vinyl acetate and N-vinylpyrrolidone (INCI: PVP/VA) are available, for example, under the trade names Luviskol VA™ (BASF) and PVP/VA (ISP).

Carboxy functional copolymers of vinylpyrrolidone, t-butyl acrylate, methacrylic acid are available, for example, under the trade name Luviskol™ VBM (BASF).

Copolymers of tert-butylacrylate, methacrylic acid and dimethicone copolyol are available, for example, under the trade name Luviflex™ Silk (BASF).

Suitable further polymers are, for example, anionic polymers. Such anionic polymers are homopolymers and copolymers, different from the (meth)acrylate polymers according to the invention, of acrylic acid and methacrylic acid or salts thereof, copolymers of acrylic acid and acrylamide and salts thereof, sodium salts of polyhydroxycarboxylic acids, copolymers of acrylic acid and methacrylic acid with, for example, hydrophobic monomers, e.g. C₄-C₃₀-alkyl esters of (meth)acrylic acid, C₄-C₃₀-alkylvinyl esters, C₄-C₃₀-alkyl vinyl ethers and hyaluronic acid and also other polymers known under the trade names Amerhold DR-25, Ultrahold™, Luviset™ P.U.R., Acronal™, Acudyne™, Lovocryl™, Versatyl™, Amphomer™ (28-4910, LV-71), Placise™ L53, Gantrez™ ES 425, Advantage Plus™, Omnirez™ 2000, Resyn™ 28-1310, Resyn™ 28-2930, Balance™ (0/55), Acudyne™ 255, Aristoflex™A or Eastman AQ™.

Water-soluble or water-dispersible polyesters, polyureas, copolyurethane ureas, maleic anhydride copolymers optionally reacted with alcohols, or anionic polysiloxanes may also be suitable as additional polymers.

Further suitable additional polymers are, for example, also cationic polymers with the INCI name Polyquaternium, such as, for example,
copolymers of N-vinylpyrrolidone/N-vinylimidazolium salts (obtainable, for example, under the trade names Luviquat™ FC, Luviquat™ HM, Luviquat™ MS, Luviquat™ Care (BASF),
copolymers of N-vinylcaprolactam/N-vinylpyrrolidone/N-vinylimidazolium salts (obtainable, for example, under the trade name Luviquat Hold™),
copolymers of N-vinylpyrrolidone/dimethylaminoethyl methacrylate, quaternized with diethylsulfate (obtainable, for example, under the trade name Luviquat™ PQ11),
cationic cellulose derivatives (polyquaternium-4 and -10),
acrylamide copolymers (polyquaternium-7),
Styleeze™ CC-10, Aquaflex™ SF-40,
guar hydroxypropyltrimethylammonium chloride (INCI: Hydroxypropyl Guar Hydroxypropyltrimonium Chloride),
polyethyleneimines and salts thereof,
polyvinylamines and salts thereof.

Suitable further hair cosmetic polymers are also neutral polymers, such as polyvinylpyrrolidone, copolymers of N-vinylpyrrolidone and vinyl acetate and/or vinyl propionate, polysiloxanes, polyvinylcaprolactam and copolymers with N-vinylpyrrolidone, cellulose derivatives, polyaspartic acid salts and derivatives. These include those known under the trade names Luviskol™ (K, VA, Plus), PVP K, PVP/VA, Advantage™HC and H₂OLD EP-1.

Furthermore, biopolymers are also suitable, i.e. polymers which are obtained from naturally renewable raw materials and are constructed from natural monomer building blocks, e.g. cellulose derivatives, chitin, chitosan, DNA, hyaluronic acid and RNA derivatives.

Further suitable polymers are also betainic polymers, such as Yukaformer (R205, SM) and Diaformer.

### Surfactants

Suitable anionic surfactants are, for example, alkyl sulfates, alkyl ether sulfates, alkylsulfonates, alkylarylsulfonates, alkyl succinates, alkyl sulfosuccinates, N-alkoylsarcosinates, acyl taurates, acyl isothionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts. The alkyl ether sulfates, alkyl ether phosphates, alkyl glycol alkoxylates and diglycol alkoxylates and alkyl ether carboxylates can have between 1 and 10 ethylene oxide or propylene oxide units, preferably 1 to 3 ethylene oxide units, in the molecule.

For example, sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate are suitable.

Suitable amphoteric surfactants are, for example, alkylbetaines, alkylamidopropylbetaines, alkylsulfobetaines, alkyl glycinates, alkyl carboxyglycinates, alkyl amphoacetates or amphopropionates, alkyl amphodiacetates or dipropionates.

For example, cocodimethylsulfopropylbetaine, laurylbetaine, cocamidopropylbetaine or sodium cocamphopropionate can be used.

Suitable nonionic surfactants are, for example, the reaction products of aliphatic alcohols or alkylphenols having 6 to 20 carbon atoms in the alkyl chain, which may be linear or branched, with ethylene oxide and/or propylene oxide. The amount of alkylene oxide is about 6 to 60 mol per mole of alcohol. Also suitable are alkylamine oxides, mono- or dialkylalkanolamides, fatty acid esters of polyethylene glycols, ethoxylated fatty acid amides, alkyl polyglycosides, alkyl glycol alkoxylates and diglycol alkoxylates or sorbitan ether esters.

Furthermore, the compositions may comprise customary cationic surfactants, such as, for example, quaternary ammonium compounds, for example cetyltrimethylammonium chloride.

If the (meth)acrylate polymers according to the invention are used in shampoo formulations, then these usually comprise anionic surfactants as base surfactants, and amphoteric and nonionic surfactants as cosurfactants.

With regard to the structure and preparation of the substances, reference may be made to the relevant overview works, such as, for example, J. Falbe (ed.), “Surfactants in Consumer Products”, Springer Verlag, Berlin, 1987, pp. 54-124 or J. Falbe (ed.), “Katalysatoren, Tenside und Mineralöladditive” [Catalysts, Surfactants and Mineral oil additives], Thieme Verlag, Stuttgart, 1978, pp. 123-217.

The cosmetic preparations usually comprise 2 to 50% by weight of surfactants, preferably 5 to 40% by weight, particularly preferably 8 to 30% by weight.

### Oil Bodies

Suitable oil bodies are, for example, Guerbet alcohols based on fatty alcohols having 6 to 18, preferably 8 to 10, carbon atoms, esters of linear C₆-C₂₂-fatty acids with linear C₆-C₂₂-fatty alcohols, esters of branched C₆-C₁₃-carboxylic acids with linear C₆-C₂₂-fatty alcohols, esters of linear C₆-C₂₂-fatty acids with branched alcohols, in particular 2-ethylhexanol, ester of hydroxycarboxylic acids with linear or branched C₆-C₂₂-fatty alcohols, in particular dioctyl 2-hydroxysuccinate, esters of linear and/or branched fatty acids with polyhydric alcohols (such as, for example, propylene glycol, dimerdiol or trimertriol) and/or Guerbet alcohols, triglycerides based on C₆-C₁₀-fatty acids, liquid mono-/di-/triglyceride mixtures based on C₆-C₁₈-fatty acids, esters of C₆-C₂₂-fatty alcohols and/or Guerbet alcohols with aromatic carboxylic acids, in particular benzoic acid, vegetable oils, branched primary alcohols, substituted cyclohexanes, linear and branched C₆-C₂₂-fatty alcohol carbonates, Guerbet carbonates, esters of benzoic acid with linear and/or branched C₆-C₂₂-alcohols (e.g. Finsolvâ TN), linear or branched, symmetrical or asymmetrical dialkyl ethers having 6 to 22 carbon atoms per alkyl group, ring-opening products of epoxidized fatty acid esters with polyols, silicone oils and/or aliphatic or naphthenic hydrocarbons.

### Emulsifiers

Suitable emulsifiers are, for example, nonionogenic surfactants from at least one of the following groups:
(1) addition products of from 2 to 30 mol of ethylene oxide and/or 0 to 5 mol of propylene oxide onto linear fatty alcohols having 8 to 22 carbon atoms, onto fatty acids having 12 to 22 carbon atoms and onto alkylphenols having 8 to 15 carbon atoms in the alkyl group;
(2) C12/18-fatty acid monoesters and diesters of addition products of from 1 to 30 mol of ethylene oxide onto glycerol;
(3) glycerol monoesters and diesters and sorbitan monoesters and diesters of saturated and unsaturated fatty acids having 6 to 22 carbon atoms and the ethylene oxide addition products thereof;
(4) alkyl monoglycosides and oligoglycosides having 8 to 22 carbon atoms in the alkyl radical and ethoxylated analogs thereof;
(5) addition products of from 15 to 60 mol of ethylene oxide onto castor oil and/or hydrogenated castor oil;
(6) polyol and, in particular polyglycerol, esters, such as, for example, polyglycerol polyricinoleate, polyglycerol poly-12-hydroxystearate or polyglycerol dimerate. Likewise suitable are mixtures of compounds from two or more of these classes of substance;
(7) addition products of from 2 to 15 mol of ethylene oxide onto castor oil and/or hydrogenated castor oil;
(8) partial esters based on linear, branched, unsaturated or saturated C_{6/22}-fatty acids, ricinoleic acid and 12-hydroxystearic acid and glycerol, polyglycerol, pentaerythritol, dipentaerythritol, sugar alcohols (e.g. sorbitol), alkyl glucosides (e.g. methylglucoside, butylglucoside, laurylglucoside), and polyglucosides (e.g. cellulose);
(9) mono-, di- and trialkyl phosphates, and mono-, di- and/or Tri-PEG alkyl phosphates and salts thereof;
(10) wool wax alcohols;
(11) polysiloxane-polyalkyl-polyether copolymers and corresponding derivatives;
(12) mixed esters of pentaerythritol, fatty acids, citric acid and fatty alcohol as in German patent 1165574 and/or mixed esters of fatty acids having 6 to 22 carbon atoms, methylglycose and polyols, preferably glycerol or polyglycerol, and
(13) polyalkylene glycols.

The addition products of ethylene oxide and/or of propylene oxide onto fatty alcohols, fatty acids, alkyl phenols, glycerol monoesters and diesters, and sorbitan monoesters and diesters of fatty acids or onto castor oil are known, commercially available products. These are homolog mixtures whose average degree of alkoxylation corresponds to the ratio of the quantitative amounts of ethylene oxide and/or propylene oxide and substrate with which the addition reaction is carried out. C₁₂-C₁₈-Fatty acid monoesters and diesters of addition products of ethylene oxide onto glycerol are known from German patent 2024051 as refatting agents for cosmetic preparations. C₈-C₁₈-Alkyl mono- and oligoglycosides, their preparation and their use are known from the prior art. They are prepared, in particular, by reacting glucose or oligosaccharides with primary alcohols having 8 to 18 carbon atoms. With regard to the glycoside ester, monoglycosides in which a cyclic sugar radical is bonded to the fatty alcohol glycosidically, and also oligomeric glycosides having a degree of oligomerization up to preferably about 8 are suitable. The degree of oligomerization here is a statistical average value which is based on a homolog distribution customary for such technical-grade products.

It is also possible for the emulsifiers used to be zwitterionic surfactants. Zwitterionic surfactants is the term used to refer to those surface-active compounds which carry at least one quaternary ammonium group and at least one carboxylate and/or one sulfonate group in the molecule. Particularly suitable zwitterionic surfactants are the so-called betaines, such as the N-alkyl-N,N-dimethylammonium glycinates, for example cocoalkyldimethylammonium glycinate, N-acylaminopropyl-N,N-dimethylammonium glycinates, for example cocoacylaminopropyldimethylammonium glycinate, and 2-alkyl-3-carboxylmethyl-3-hydroxyethylimidazolines having in each case 8 to 18 carbon atoms in the alkyl or acyl group, and cocoacylaminoethylhydroxyethylcarboxymethylglycinate.

Particular preference is given to the fatty acid amide derivative known under the CTFA name Cocamidopropyl Betaine. Likewise suitable emulsifiers are ampholytic surfactants. Ampholytic surfactants are understood as meaning those surface-active compounds which, apart from a C₈-C₁₈-alkyl or -acyl group in the molecule, contain at least one free amino group and at least one —COOH and/or —SO₃H group and are capable of forming internal salts. Examples of suitable ampholytic surfactants are N-alkylglycines, N-alkylpropionic acids, N-alkylaminobutyric acids, N-alkyliminodipropionic acids, N-hydroxyethyl-N-alkylamidopropylglycines, N-alkyltaurines, N-alkylsarcosines, 2-alkylaminopropionic acids and alkylaminoacetic acids having in each case about 8 to 18 carbon atoms in the alkyl group. Particularly preferred ampholytic surfactants are N-cocoalkylaminopropionate, cocoacylaminoethylaminopropionate and C₁₂ to C₁₈-acylsarcosine.

Besides the ampholytic emulsifiers, quaternary emulsifiers are also suitable, particular preference being given to those of the ester quat type, preferably methyl-quaternized difatty acid triethanolamine ester salts.

### Superfatting Agents

Superfatting agents which may be used are substances such as, for example lanolin and lecithin, and also polyethoxylated or acylated lanolin and lecithin derivatives, polyol fatty acid esters, monoglycerides and fatty acid alkanolamides, the latter also serving as foam stabilizers.

### Pearlescent Waxes

Examples of suitable pearlescent waxes are: alkylene glycol esters, specifically ethylene glycol distearate; fatty acid alkanolamides, specifically coconut fatty acid diethanolamide, partial glycerides, specifically stearic acid monoglyceride; esters of polybasic, optionally hydroxyl-substituted carboxylic acids with fatty alcohols having 6 to 22 carbon atoms, specifically long-chain esters of tartaric acid; fatty substances, such as, for example, fatty alcohols, fatty ketones, fatty aldehydes, fatty ethers and fatty carbonates which have a total of at least 24 carbon atoms, specifically laurone and distearyl ether; fatty acids, such as stearic acid, hydroxystearic acid or behenic acid, ring-opening products of olefin epoxides having 12 to 22 carbon atoms with fatty alcohol having 12 to 22 carbon atoms and/or polyols having 2 to 15 carbon atoms and 2 to 10 hydroxyl groups, and mixtures thereof.

### Bodying Agents

Suitable bodying agents are primarily fatty alcohols or hydroxy fatty alcohols having 12 to 22 and, preferably, 16 to 18, carbon atoms, and also partial glycerides, fatty acids or hydroxy fatty acids. Preference is given to a combination of these substances with alkyl oligoglucosides and/or fatty acid N-methylglucamides of identical chain length and/or polyglycerol poly-12-hydroxystearates. Suitable thickeners are, for example, polysaccharides, in particular xanthan gum, guar-guar, agar-agar, alginates and tyloses, carboxymethylcellulose and hydroxyethylcellulose, and also relatively high molecular weight polyethylene glycol monoesters and diesters of fatty acids, polyacrylates (e.g. Carbopol™ from Goodrich or Synthalen™ from Sigma), polyacryl-amides, polyvinyl alcohol and polyvinylpyrrolidone, surfactants, such as, for example, ethoxylated fatty acid glycerides, esters of fatty acids with polyols, such as, for example pentaerythritol or trimethylolpropane, fatty alcohol ethoxylates with a narrowed homolog distribution or alkyl oligoglucosides, and electrolytes, such as sodium chloride and ammonium chloride.

### Fats

Typical examples of fats are glycerides, and suitable waxes are, inter alia, beeswax, carnauba wax, candelilla wax, montan wax, paraffin wax or microcrystalline waxes, if appropriate in combination with hydrophilic waxes, e.g. cetylstearyl alcohol or partial glycerides. Stabilizers which may be used are metal salts of fatty acids, such as, for example, magnesium, calcium, aluminum and/or zinc stearate or ricinoleate. Suitable silicone compounds are, for example, dimethylpolysiloxanes, methylphenyl-polysiloxanes, cyclic silicones, and amino-, fatty acid-, alcohol-, polyether-, epoxy-, fluorine-, glycoside- and/or alkyl-modified silicone compounds, which can either be in liquid or resin form at room temperature.

### Hydrotropic Agents

To improve the flow behavior, it is also possible to use hydrotropic agents, such as, for example, ethanol, isopropyl alcohol or polyols. Polyols which are suitable here preferably have 2 to 15 carbon atoms and at least two hydroxyl groups. Typical examples are
glycerol;
alkylene glycols, such as, for example, ethylene glycol, diethylene glycol, propylene glycol, butylene glycol, hexylene glycol, and polyethylene glycols with an average molecular weight of from 100 to 1000 daltons; technical-grade oligoglycerol mixtures with a degree of self-condensation of from 1.5 to 10, such as, for example, technical-grade diglycerol mixtures with a diglycerol content of from 40 to 50% by weight;
methylol compounds, such as, in particular, trimethylolethane, trimethylolpropane, trimethylolbutane, pentaerythritol and dipentaerythritol;
lower alkyl glucosides, in particular those having 1 to 8 carbon atoms in the alkyl radical, such as, for example, methyl- and butylglucoside;
sugar alcohols having 5 to 12 carbon atoms, such as, for example, sorbitol or mannitol;
sugars having 5 to 12 carbon atoms, such as, for example, glucose or sucrose;
amino sugars, such as, for example, glucamine.

### Preservatives

Examples of suitable preservatives are phenoxyethanol, formaldehyde solution, parabens, pentanediol or sorbic acid, and the other classes of substance listed in Appendix 6, Part A and B, of the Cosmetics Directive.

### Perfume Oils

The addition of perfume oils to conceal the odor of the polymers is not necessary.

If appropriate, the cosmetic preparations may nevertheless comprise perfume oils. Perfume oils which may be mentioned are, for example, mixtures of natural and synthetic fragrances. Natural fragrances are extracts from flowers (lily, lavender, rose, jasmine, neroli, ylang-ylang), stems and leaves (geranium, patchouli, petitgrain), fruits (aniseed, coriander, cumene, juniper), fruit peels (bergamot, lemon, orange), roots (mace, angelica, celery, cardamon, costus, iris, calmus), woods (pinewood, sandalwood, guaiac wood, cedar wood, rosewood), herbs and grasses (tarragon, lemongrass, sage, thyme), needles and branches (spruce, fir, pine, dwarf-pine), resins and balsams (galbanum, elemi, benzoin, myrrh, olibanum, opoponax). Also suitable are animal raw materials, such as, for example, civet and castoreum. Typical synthetic fragrance compounds are products of the ester, ether, aldehyde, ketone, alcohol and hydrocarbon type. Fragrance compounds of the ester type are, for example, benzyl acetate, phenoxyethyl isobutyrate, 4-tert-butylcyclohexyl acetate, linalyl acetate, dimethylbenzylcarbinyl acetate, phenylethyl acetate, linalyl benzoate, benzyl formate, ethyl methylphenyl glycinate, allyl cyclohexylpropionate, styrallyl propionate and benzyl salicylate. The ethers include, for example, benzyl ethyl ether, the aldehydes include, for example, the linear alkanals having 8 to 18 carbon atoms, citral, citronellal, citronellyloxyacetaldehyde, cyclamenaldehyde, hydroxycitronellal, lilial and bourgeonal, and the ketones include, for example, the ionones, cc-isomethylionene and methyl cedryl ketone, and the alcohols include anethole, citronellol, eugenol, isoeugenol, geraniol, linalool, phenylethyl alcohol and terpineol, and the hydrocarbons include mainly the terpenes and balsams. However, preference is given to using mixtures of different fragrances which together produce a pleasing scent note. Essential oils of lower volatility, which are mostly used as flavor components, are also suitable as perfume oils, e.g. sage oil, chamomile oil, oil of cloves, balm oil, mint oil, cinnamon leaf oil, lime blossom oil, juniper berry oil, vetiver oil, olibanum oil, galbanum oil, labolanum oil and lavandin oil. Preference is given to using bergamot oil, dihydromyrcenol, lilial, lyral, citronellol, phenylethyl alcohol, α-hexylcinnamaldehyde, geraniol, benzylacetone, cyclamenaldehyde, linalool, boisambrene forte, ambroxan, indole, hedione, sandelice, lemon oil, mandarin oil, orange oil, allyl amyl glycolate, cyclovertal, lavandin oil, clary sage oil, -damascone, geranium oil bourbon, cyclohexyl salicylate, Vertofix Coeur, Iso-E-Super, Fixolide NP, evernyl, iraldein gamma, phenylacetic acid, geranyl acetate, benzyl acetate, rose oxide, Romillat, Irotyl and Floramat alone or in mixtures.

### Dyes

Dyes which may be used are the substances approved and suitable for cosmetic purposes, as are listed, for example, in the publication “Kosmetische Färbemittel” [Cosmetic Colorants] from the Farbstoffkommission der Deutschen Forschungsgemeinschaft [Dyes Commission of the German Research Council], Verlag Chemie, Weinheim, 1984, pp. 81-106. These dyes are usually used in concentrations of from 0.001 to 0.1% by weight, based on the total mixture.

The total amount of the auxiliaries and additives can be 1 to 50% by weight, preferably 5 to 40% by weight, based on the compositions.

### Oral Care and Dental Care

The polymers according to the invention are readily soluble in solvents and solvent mixtures with an increased water fraction. Due to the ability of the polymers according to the invention to form films with good mechanical properties, they can be used in preparations for dental care. Possible supply forms are, for example, dental creams, dental cleaning gelee, chewing gums or mouth rinses.

The polymers according to the invention are provided in the unneutralized form, partially neutralized form or completely neutralized form, preferably in the unneutralized or partially neutralized form, for oral care and dental care. The polymers according to the invention and the films from these polymers are accordingly preferably in an anionic charge state.

Besides the polymers according to the invention, the compositions for oral care and dental care comprise customary constituents, such as abrasives and polishes (for example chalk), humectants (for example sorbitol, glycerol, polyethylene glycols), surfactants (for example lauryl sulfate, betaines, alkyl polyglucosides), aroma components, consistency regulators, deodorizing active ingredients, swelling substances, binders (for example carboxymethylcellulose, xanthan gum), active ingredients to fight oral or dental disorders, water-soluble fluorine compounds (for example sodium fluoride). Typical examples of anionic surfactants are soaps, alkylbenzenesulfonates, alkanesulfonates, alkyl ether sulfonates, glycerol ether sulfonates, α-methyl ester sulfonates, sulfofatty acids, glycerol ether sulfates, hydroxy mixed ether sulfates, fatty acid amide (ether) sulfates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids, such as, for example, acyl lactylates, acyl tartrates, acyl glutamates and acyl aspartates, alkyl oligoglucoside sulfates, protein fatty acid condensates (in particular plant products based on wheat) and alkyl (ether) phosphates. If the anionic surfactants contain polyglycol ether chains, these may have a conventional homolog distribution, but preferably have a narrowed homolog distribution. Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers or mixed formals, glucoronic acid derivatives, fatty acid N-alkylglucamides, protein hydrolyzates (in particular plant products based on wheat), polyol fatty acid esters, sugar esters, sorbitan esters, polysorbates and amine oxides. If the nonionic surfactants contain polyglycol ether chains, these may have a conventional homolog distribution, but preferably have a narrowed homolog distribution. Typical examples of amphoteric or zwitterionic surfactants are aminopropionates, aminoglycinates. Besides olefinsulfonates, betaines, monoglyceride (ether) sulfates and alkyl and/or alkenyl oligoglycosides, mono- and dialkyl sulfosuccinates and/or taurates are added to the alkoxylated carboxylic esters as further surfactants. Said surfactants are exclusively known compounds. With regard to the structure and preparation of these substances, reference may be made to the relevant overview works, for example J. Falbe (ed.), “Surfactants in Consumer Products”, Springer Verlag, Berlin, 1987, pp. 54-124 or J. Falbe (ed.), “Katalysatoren, Tenside und Mineralbladditive” [Catalysts, Surfactants and Mineral oil additives], Thieme Verlag, Stuttgart, 1978, pp. 123-217.

The proportion of auxiliaries and additives is unimportant per se and depends on the type of composition to be ultimately formulated. Usually, the content is 5 to 98% by weight, preferably 80 to 90% by weight-based on the finished preparations.

### Measurement Methods

Determination of the K Value

The K values are measured in accordance with Fikentscher, Cellulosechemie [Cellulose Chemistry], Vol. 13, pp. 58 to 64 (1932) at 25° C. in aqueous/ethanolic or ethanolic solution and are a measure of the molar weight. The aqueous/ethanolic or ethanolic solution of the polymers comprises 1 g of polymer in 100 ml of solution. If the polymers are in the form of aqueous dispersions, corresponding amounts of the dispersion, depending on the polymer content of the dispersion, are topped up to 100 ml with ethanol such that the concentration is 1 g of polymer in 100 ml of solution.

The K value is measured in a micro-Ubbelohde capillary type M Ic from Schott.

Calculation of the K Value with Mixing Correction for Water in Ethanol

The factors listed below in the equation for the mixing correction refer exclusively to this type of capillary at a measurement temperature of 25° C.

### Calculation of the K Value:

### K Value:

$$K = k * 1000 ; z = {η}_{rel}$$

$$k = \frac{( 1.5 log z - 1 ) c \pm \sqrt{[ {( 1.5 log z - 1 )}^{2} {c}^{2} + 4 ( 75 c + 1.5 {c}^{2} ) ( log z ) ]}}{2 ( 75 c + 1.5 {c}^{2} )}$$

### Relative Viscosity:

ηᵣₑₗ=(tₛₗₙ−HCₛₗₙ)/(tₛₒₗ−HCₛₒₗ)

### Calculation of the Mixing Correction:

Mixtures of water in ethanol exhibit nonproportional changes in the viscosity of the solvent mixture relative to the content of water.

Due to the nature of the sample (aqueous dispersion of a polymer), water is introduced into the ethanolic sample solution through the initial weight of the sample. This amount of water is included in the run time of the solvent by virtue of the mixing correction, such that the relative viscosity is corrected in accordance with the addition of water.

### Run Time of the Solvent Mixture:

tₛₒₗ=t₀+t_{M}

### Run Time Correction:

$${t}_{M} = - 7.486100 e - 5 * {c}_{w}^{4} + 3.785884 E - 3 * {c}_{w}^{3} - 8.063441 E - 2 * {c}_{w}^{2} + 1.999207 * {c}_{w} + 2.959258 E - 2$$

### Water Content in Solvent:

c_{w}=c/SC/100*(1−SC/100)

c concentration of the measurement solution [g/100 ml]
c_{W} concentration of water in the measurement solution [g/100 ml]
SC solids content in the sample [g/100 g]
HCₛₒₗ Hagenbach correction of the solvent [-s]
HCl in Hagenbach correction of the measurement solution [-s]
tₛₒₗ run time of the solvent, mixing-corrected [s]
tₛₗₙ run time of the measurement solution, measured [s]
t₀ run time of the solvent, measured [s]
t_{M} run time correction for the solvent mixture, calculated [s]
z ηᵣₑₗ in the Fikentscher equation (K value calculation)

### Determination of the Clarity as Aerosol

The clarity of an aerosol spray formulation is determined in pressure-resistant, thick-walled glass aerosol vessels by visual means. “Clear” is the term used for a formulation without any opacity, streaking or flocculation (precipitation).

### Determination of the Flexural Rigidity

Apart from the subjective assessment, the strength of polymeric film formers is also measured physically as the flexural rigidity of thin tresses of hair which have been treated with the polymer solution and dried again. Here, a force transducer determines the force required for the bending, the entire measurement proceeding under standardized conditions in a climatically controlled room at 65% relative atmospheric humidity.

To measure the flexural rigidity, 3.0% strength by weight solutions of the polymers according to the invention were prepared. The measurement of the flexural rigidity was carried out on 5 to 10 hair tresses (each ca. 3 g and 24 cm in length) at 20° C. and 65% relative humidity. The weighed dry hair tresses were immersed into the 3.0% strength by weight polymer solution, with triple immersion and removal ensuring uniform distribution. The excess film former solution was then stripped off between thumb and index finger, and the hair tresses were then carefully squeezed by squeezing between filter papers. The tresses were then shaped by hand such that they had a round cross section.

Drying was carried out overnight at 20° C. and 65% relative humidity in the climatically controlled room.

The tests were carried out in a climatically controlled room at 20° C. and 65% relative humidity using a tensile/pressure testing instrument. The hair tress was placed symmetrically on two cylindrical rolls of the sample holder. The tress was then bent exactly in the middle from above using a 40 mm rounded punch (breakage of the polymer film). The force required for this was measured using a load cell (50 N) and given in Newtons.

### Determination of the Droplet Size Distribution

The particle sizes of the liquid aerosols were determined using the scattered light analysis method using a commercial Malvern™ Master Sizer X (Malvern Instruments Inc., Southborough Mass., USA).

### Measurement Principle:

The measurement system is based on the laser light diffraction at the particle. Apart from being suitable for spray analysis (aerosols, pump sprays), this method is also suitable for determining the size of solids, suspensions and emulsions in the size range from 0.1 μm to 2000 μm.

A particle collective (=droplet) is illuminated by a laser. At each droplet, some of the incident laser light is scattered. This light is captured on a multielement detector, and the appertaining light energy distribution is determined. The appertaining particle distribution is calculated from this data using the evaluation software.

### Procedure:

The aerosols were sprayed at a distance of 29.5 cm relative to the laser beam. The spray cone was at a right angle to the laser beam.

The aerosol cans were fixed prior to each measurement to a fixedly installed holding device so that all of the aerosols to be tested were measured at exactly the same distance.

Prior to the actual particle measurement, a measurement of the background was carried out. This in principle allows the effects of dust and other contaminants within the measurement area to be eliminated during measurement.

The aerosol was then sprayed into the test area. The total particle volume was ascertained over a test period of 2 seconds and evaluated.

### Evaluation:

The evaluation comprises a tabular representation over 32 class widths from 0.5 μm to 2000 μm and additionally a graphical representation of the particle size distribution. Since the distribution was uniform in the spray experiments, the mean diameter D(v,0.5) was given.

For readily sprayable aerosol systems in the cosmetic sector, this value is below 120 μm, preferably below 100 μm, particularly preferably in the range from 30 μm to 70 μm, depending on polymer content, valve, spray head geometry, solvent ratio and amounts of propellant gas.

The following were used

as valve A: Seaquist Perfect; cone 0.32 mm, 0.50 VPH 0.40 mm (239436)
as spray head: SK1 (yellow); DU381

### EXAMPLES

### Examples for the Preparation of the Polymers According to the Invention

### Example S1

### tert-Butyl acrylate/ethyl acrylate/methacrylic acid 69/10/21 w/w/w

At a temperature of from 20 to 25° C.

| | | |
|---|---|---|
| 400 | g | of deionized water |
| 0.6 | g | of a 15% strength by weight aqueous solution of |
| | | sodium lauryl sulfate in deionized water |
| 35 | g | of feed II (see below) |

were initially introduced into a 2 l polymerization vessel with stirrer and heating and cooling devices and heated to 45° C. with stirring and under a nitrogen atmosphere. After reaching the temperature, feed I was added over the course of 5 minutes. The mixture was then heated to 80° C. and, with stirring and retention of the reaction temperature, feed II was metered in over the course of 3 hours with constant feed streams.

When the feeds were complete, the reaction mixture was stirred for a further hour at 80° C. and then cooled to 60° C.

While retaining the temperature of 60° C., feed III was added. The mixture was then cooled to 35° C. and, with retention of the reaction temperature, feed IV was added.

Feed I:

| | |
|---|---|
| 6 g | of 7% strength by weight aqueous solution of sodium persulfate in |
| | deionized water |

Feed II is an aqueous monomer emulsion prepared from:

| Initial | | % by weight based |
|---|---|---|
| weight | | on the total |
| [g] | | amount of monomer |
| 204 | of deionized water | |
| 8 | of a 15% strength by weight aqueous | |
| | solution of sodium lauryl sulfate in | |
| | deionized water | |
| 10 | of nonionic emulsifier* | |
| 273 | of tert-butyl acrylate | 69 |
| 40 | of ethyl acrylate | 10 |
| 83 | of methacrylic acid | 21 |
| 2.4 | of n-dodecylmercaptan | 0.60 |

*for example, TweenTM 80 can be used as nonionic emulsifier.

### Preparation of Feed II

The total amount of the 15% strength by weight aqueous solution of sodium lauryl sulfate was added to the initial charge of deionized water with stirring. In the order given, the corresponding amounts

1) of t-butyl acrylate,
2) of a solution of a nonionic emulsifier in ethyl acrylate,
3) of methacrylic acid and
4) of n-dodecyl mercaptan were added to the homogeneous solution, which was further stirred.

### Feed III:

| | | % by weight of hydrogen peroxide |
|---|---|---|
| | | based on the total amount of monomer |
| 4 g | of 30% strength by weight | 0.3 |
| | solution of hydrogen | |
| | peroxide in deionized water | |

### Feed IV:

| | | % by weight of ammonium |
|---|---|---|
| | | hydrogencarbonate |
| | | based on the total |
| | | amount of monomer |
| 40 g | of 10% strength by weight | 1.01 |
| | solution of ammonium | |
| | hydrogencarbonate in | |
| | deionized water | |

The polymers of Examples 3 to 7 according to the invention were synthesized analogously to Example 2, feed II being chosen accordingly as given below for each example.

EXAMPLE S2

| | Mass | % by weight based on the |
|---|---|---|
| | [g] | total amount of the monomers |
| Na lauryl sulfate/Texapon | 8 | |
| Nonionic emulsifier | 10 | |
| Water | 204 | |
| t-Butyl acrylate | 273 | 69 |
| Ethyl acrylate | 40 | 10 |
| Methacrylic acid | 83 | 21 |
| n-Dodecyl mercaptan | 2.8 | 0.70 |

EXAMPLE S3

| | Mass | % by weight based on the |
|---|---|---|
| | [g] | total amount of the monomers |
| Na lauryl sulfate/Texapon | 8 | |
| Nonionic emulsifier | 10 | |
| Water | 204 | |
| t-Butyl acrylate | 304 | 77 |
| Ethyl acrylate | 8 | 2 |
| Methacrylic acid | 83 | 21 |
| n-Dodecyl mercaptan | 2.8 | 0.70 |

EXAMPLE S4

| | Mass | % by weight based on the |
|---|---|---|
| | [g] | total amount of the monomers |
| Na lauryl sulfate/Texapon | 8 | |
| Nonionic emulsifier | 10 | |
| Water | 204 | |
| t-Butyl acrylate | 273 | 69 |
| Ethyl acrylate | 40 | 10 |
| Methacrylic acid | 83 | 21 |
| n-Dodecyl mercaptan | 3.6 | 0.90 |

EXAMPLE S5

| | Mass | % by weight based on the |
|---|---|---|
| | [g] | total amount of the monomers |
| Na lauryl sulfate/Texapon | 8 | |
| Nonionic emulsifier | 10 | |
| Water | 204 | |
| t-Butyl acrylate | 269 | 68 |
| Ethyl acrylate | 8 | 2 |
| Methacrylic acid | 119 | 30 |
| n-Dodecyl mercaptan | 2.8 | 0.70 |

EXAMPLE S6

| | Mass | % by weight based on the |
|---|---|---|
| | [g] | total amount of the monomers |
| Na lauryl sulfate/Texapon | 8 | |
| Nonionic emulsifier | 10 | |
| Water | 204 | |
| t-Butyl acrylate | 249 | 63 |
| Ethyl acrylate | 8 | 2 |
| Methacrylic acid | 138 | 35 |
| n-Dodecyl mercaptan | 2.8 | 0.70 |

EXAMPLE S7

| | Mass | % by weight based on the |
|---|---|---|
| | [g] | total amount of the monomers |
| Na lauryl sulfate/Texapon | 8 | |
| Nonionic emulsifier | 10 | |
| Water | 204 | |
| t-Butyl acrylate | 312 | 79 |
| Ethyl acrylate | 0 | 0 |
| Methacrylic acid | 83 | 21 |
| n-Dodecyl mercaptan | 2.8 | 0.70 |

### Formulation Examples (FE)

### Example FE1

### Hairspray as VOC 55 Formulation

| % by wt. | INCI: |
|---|---|
| 5.00 | Copolymer 53 according to the invention |
| 0.5-3.0 | Aminomethyl Propanol (according to DN*) |
| q.s. | Fragrance |
| 15.00 | Alcohol |
| ad 100 | Water |
| 40.00 | Dimethyl Ether |

*DN means “degree of neutralization”

Example FE 1 was repeated using copolymers S1, S2, S4, S5, S6, S7.

### Example FE 2

### Hairspray with Some Additives as VOC 55 Formulation

| % by wt. | INCI: |
|---|---|
| 5.00 | Copolymer 53 according to the invention |
| 0.5-3.0 | Aminomethyl Propanol (according to DN) |
| 0.10 | Dimethicone Copolyol |
| 0.03 | PPG-3 Methyl Ether |
| 0.10 | Panthenol |
| 0.10 | Benzophenone-3 |
| 0.10 | Niacinamide |
| q.s. | Fragrance |
| 15.00 | Alcohol |
| ad 100 | Water |
| 40.00 | Dimethyl ether |

Example FE 2 was repeated using copolymers S1, S2, S4, S5, S6, S7.

### Example FE 3

### Hairspray with HF 152A as VOC 55 Formulation

| % by wt. | INCI: |
|---|---|
| 4.00 | Copolymer 53 according to the invention |
| 0.5-1.3 | Aminomethyl Propanol (according to DN) |
| 55.00 | Alcohol |
| q.s. | Fragrance |
| ad 100 | Water |
| 40.00 | Hydrofluorocarbon 152a |

Example FE 3 was repeated using copolymers S1, S2, S4, S5, S6, S7.

### Example FE 4

### Hairspray with HF 152A and DME as VOC 55 Formulation

| % by wt. | INCI: |
|---|---|
| 3.00 | Copolymer 53 according to the invention |
| 0.4-1.0 | Aminomethyl Propanol (according to DN) |
| 35.00 | Alcohol |
| q.s. | Fragrance |
| ad 100 | Water |
| 20.00 | Dimethyl Ether |
| 20.00 | Hydrofluorocarbon 152a |

Example FE 4 was repeated using copolymers S1, S2, S4, S5, S6, S7.

### Example FE 5

### Hairspray with Acrylates Copolymer as VOC 55 Formulation

| % by wt. | INCI: |
|---|---|
| 3.00 | Copolymer 53 according to the invention |
| 5.00 | Acrylates Copolymer |
| 0.95 | Aminomethyl Propanol |
| q.s. | Fragrance |
| 15.00 | Alcohol |
| ad 100 | Water |
| 40.00 | Dimethyl Ether |

Example FE 5 was repeated using copolymers S1, S2, S4, S5, S6, S7.

### Example FE 6

### Hairspray with Octylacrylamide/Acrylates/Butylaminoethyl Methacrylate Copolymer as VOC 55 Formulation

| % by wt. | INCI: |
|---|---|
| 2.50 | Octylacrylamide/Acrylates/Butylaminoethyl |
| | Methacrylate Copolymer |
| 2.50 | Copolymer 53 according to the invention |
| 0.80 | Aminomethyl Propanol |
| 0.03 | PPG-3 Methyl Ether |
| 0.10 | Panthenol |
| 0.20 | Phenyltrimethicone |
| 0.10 | Benzophenone-3 |
| 0.10 | Niacinamide |
| q.s. | Fragrance |
| 15.00 | Alcohol |
| ad 100 | Water |
| 40.00 | Dimethyl Ether |

Example FE 6 was repeated using copolymers S1, S2, S4, S5, S6, S7.

### Example FE 7

### Hairspray with Acrylate/Octylacrylamide Copolymer as VOC 55 Formulation

| % by wt. | INCI: |
|---|---|
| 3.00 | Copolymer 53 according to the invention |
| 1.50 | Acrylate/Octylacrylamide Copolymer |
| 0.52 | Aminomethyl Propanol |
| 0.30 | Phenyltrimethicone |
| q.s. | Fragrance |
| 15.00 | Alcohol |
| ad 100 | Water |
| 40.00 | Dimethyl Ether |

Example FE 7 was repeated using copolymers S1, S2, S4, S5, S6, S7.

### Example FE 8

### Hairspray with VA/Crotonates/Vinyl Neodecanoate as VOC 55 Formulation

| % by wt. | INCI: |
|---|---|
| 3.40 | Copolymer 53 according to the invention |
| 1.60 | VA/Crotonates/Vinyl Neodecanoate Copolymer |
| 0.2-1.0 | Aminomethyl Propanol (according to DN) |
| 0.10 | Potassium Hydroxide |
| q.s. | Fragrance |
| 15.00 | Alcohol |
| ad 100 | Water |
| 40.00 | Dimethyl Ether |

Example FE 8 was repeated using copolymers S1, S2, S4, S5, S6, S7.

### Example FE 9

### Aerosol Hairspray as VOC80 Formulation

| % by wt. | INCI: |
|---|---|
| 5.00 | Copolymer 53 according to the invention |
| 0.9-1.5 | Aminomethyl Propanol (according to DN) |
| 0.50 | Panthenol |
| 0.10 | Phytantriol |
| ad 100 | Water |
| 55.00 | Alcohol |
| q.s. | Fragrance |
| 10.00 | Butane |
| 15.00 | Dimethyl Ether |

Example FE 9 was repeated using copolymers S1, S2, S4, S5, S6, S7.

### Example FE 10

### Aerosol Hairspray with Polyurethane-1 as VOC80 Formulation

| % by wt. | INCI: |
|---|---|
| 3.00 | Copolymer 53 according to the invention |
| 5.00 | Polyurethane-1 |
| 0.1-0.4 | Aminomethyl Propanol (according to DN) |
| ad 100 | Water |
| 35.50 | Alcohol |
| 40.00 | Dimethyl Ether |

Example FE 10 was repeated using copolymers S1, S2, S4, S5, S6, S7.

### Example FE 11

### Aerosol Hairspray with PEG/PPG-25/25 Dimethicone/Acrylates Copolymer as VOC80 Formulation

| % by wt. | INCI: |
|---|---|
| 3.00 | Copolymer 53 according to the invention |
| 3.00 | PEG/PPG-25/25 Dimethicone/Acrylates Copolymer |
| 0.1-0.5 | Aminomethyl Propanol (according to DN) |
| ad 100 | Water |
| 35.50 | Alcohol |
| 40.00 | Dimethyl Ether |

Example FE 11 was repeated using copolymers S1, S2, S4, S5, S6, S7.

### Example FE 12

### Aerosol Hairspray as VOC95 Formulation

| % by wt. | INCI: |
|---|---|
| 5.00 | Copolymer 53 according to the invention |
| 0.7-1.2 | Aminomethyl Propanol (according to DN) |
| 0.10 | Dimethicone Copolyol |
| 0.10 | Cetearyl Octanoate |
| 0.10 | Panthenol |
| q.s. | Fragrance |
| ad 100 | Alcohol |
| 40.00 | Propane/Butane |

Example FE 12 was repeated using copolymers S1, S2, S4, S5, S6, S7.

### Example FE 13

### Pump Hairspray

| % by wt. | INCI: |
|---|---|
| 5.00 | Copolymer 53 according to the invention |
| 0.5-1.0 | Aminomethyl Propanol (according to DN) |
| q.s. | Fragrance |
| 55.00 | Alcohol |
| ad 100 | Water |

Example FE 13 was repeated using copolymers S1, S2, S4, S5, S6, S7.

### Example FE 14

### Pump Hairspray with VP/Methacrylamide/Vinyl Imidazole Copolymer

| % by wt. | INCI: |
|---|---|
| 3.00 | Copolymer 53 according to the invention |
| 2.00 | VP/Methacrylamide/Vinyl Imidazole Copolymer |
| 0.5-1.0 | Aminomethyl Propanol (according to DN) |
| q.s. | Fragrance |
| 55.00 | Alcohol |
| ad 100 | Water |

Example FE 14 was repeated using copolymers S1, S2, S4, S5, S6, S7.

Results of the application tests of aerosol formulations comprising the polymers according to the invention

| | | % by weight of | | | | |
|---|---|---|---|---|---|---|
| Example | | regulator based | | | | Spray image: |
| No. | Weight ratio of | on the total | | | Flexural | average |
| of the | the monomers | mass of | | Clarity as | rigidity** | particle size |
| polymers | t-BA/EA/MAA | monomers | K value | aerosol* | [cN] | [μm] |
| S1 | 69/10/21 | 0.6 | 34 | clear | 224 | 116 |
| S2 | 69/10/21 | 0.7 | 33 | clear | 205 | 70 |
| S3 | 77/2/21 | 0.7 | 32 | clear | 227 | 41 |
| S4 | 69/10/21 | 0.9 | 30 | clear | 183 | 53 |
| S5 | 68/2/30 | 0.7 | 34 | clear | 243/249 | 52 |
| S6 | 63/2/35 | 0.7 | 35 | clear | 242/260 | 48 |
| S7 | 79/0/21 | 0.7 | 31 | clear | 220 | 43 |

*VOC-55 Aerosol with 5% by weight of polymer (100% neutralized with AMP) and 40% DME
**Flexural rigidity resulting from use of VOC-55 aerosols with 3% by weight of polymer (100% neutralized with AMP)

1. A polymer obtainable by free-radical polymerization of
a) 30 to 99% by weight of tert-butyl acrylate and/or tert-butyl methacrylate as monomer A,
b) 1 to 70% by weight of acrylic acid and/or methacrylic acid as monomer B and
c) less than 5% by weight of a free-radically copolymerizable monomer or a free-radically copolymerizable monomer mixture as monomer C, where at least one of the monomers C produces a homopolymer with a glass transition temperature of less than 30° C.,
with the proviso that the % by weight add up to 100,
where the K value of the polymers is between 27 and 38, with the proviso that the polymerization is carried out in the presence of a regulator if the K value of the polymers is less than or equal to 35.

2. The polymer according to claim 1, obtainable by free-radical polymerization of
a) 60 to 80% by weight of monomer A,
b) 20 to 40% by weight of monomer B and
c) less than 5% by weight of monomer or monomer mixture C.

3. The polymer according to claim 1, where the amount of monomer C is less than 3% by weight.

4. The polymer according to claim 1, where the K value is in the range from 29 to 35.

5. The polymer according to claim 1, where the K value is in the range from 30 to 34.

6. The polymer according to claim 1, where the carboxylate groups are partially or completely neutralized.

7. The polymer according to claim 1, where
monomer A is tert-butyl acrylate,
monomer B is methacrylic acid and
monomer C is ethyl acrylate.

8. A process for the preparation of the polymers according to claim 1, which comprises free-radically polymerizing monomer A, monomer B and monomer or monomer mixture C, where the K value of the polymers is between 27 and 38, with the proviso that the polymerization is carried out in the presence of a regulator if the K value of the polymers is less than or equal to 35.

9. (canceled)

10. (canceled)

11. (canceled)

12. A film former comprising the polymer according to claim 1.

13. A cosmetic preparation comprising the polymer according to claim 1.

14. A preparation for oral care and dental care comprising the polymer according to claim 1.

15. A hair cosmetic preparation comprising the polymer according to claim 1.
